(19) United States
(12) Patent Application Publication
(10) Pub. No.: US 2026/0261966 A1
(43) Pub. Date: Sep. 3, 2026

(54) SERVICE MANAGEMENT ORCHESTRATION DRIVEN NETWORK ENERGY SAVING USING O1 INTERFACE

(71) Applicant: RAKUTEN MOBILE, INC., Tokyo (JP)

(72) Inventors: Lingasamy VELUCHAMY, Tokyo (JP); Awn MUHAMMAD, Tokyo (JP)

(73) Assignee: RAKUTEN MOBILE, INC., Tokyo (JP)

(21) Appl. No.: 18/865,774

(22) PCT Filed: Aug. 16, 2024
(86) PCT No.: PCT/US2024/042646

§ 371 Date: Nov. 14, 2024

(30) Foreign Application Priority Data
Aug. 17, 2023 (IN) 202341055270

(51) Int. Cl. H04W 52/02

(52) U.S. Cl. CPC H04W 52/0203; H04W 52/028

(57) ABSTRACT

A method, apparatus, and system for Service Management and Orchestration (SMO) network energy saving (NES) using an O1 interface may be provided and may include, receiving, by a SMO of an Open Radio Access Network (O-RAN), NES information from at least one of a O-RAN Distributed Unit (O-DU) and a O-RAN Centralized Unit (O-CU) wherein the NES information includes capability exposing information received from an O-RAN Radio Unit (O-RU); determining, by the SMO based at least in part on the NES information, whether to activate an NES use-case; based on determining to activate the NES use-case, sending, by the SMO, a trigger to activate the NES use-case; and receiving, by the SMO, a first notification indicating a change in a state of the NES use-case.

### FIELD

The present disclosure relates to Service Management and Orchestration (SMO) driven network energy saving (NES) implementations using O1 interface.

### BACKGROUND

The information disclosed in this background section is only for enhancement of understanding of the general background of the disclosure and should not be taken as an acknowledgement or any form of suggestion that this information forms the prior art already known to a person skilled in the art.

A radio access network (RAN) is an important component in a telecommunications system, as it connects end-user devices (or user equipment) to other parts of the network. The RAN includes a combination of various network elements (NEs) that connect end-users to a core network. Traditionally, hardware and/or software of a particular RAN is vendor specific.

Open RAN (O-RAN) technology has emerged to enable multiple vendors to provide hardware and/or software to a telecommunications system. Since different vendors are involved, the type of hardware and/or software provided may also be different. That is, different types of NEs may be provided by different vendors, and depending on the specific service, the NE could be virtualized in software form (e.g., virtual machine (VM)-based), or could be in physical hardware form (e.g., non-VM based).

To this end, O-RAN disaggregates the RAN functions into a centralized unit (CU), a distributed unit (DU), and a radio unit (RU). The CU may be a logical node for hosting Radio Resource Control (RRC), Service Data Adaptation Protocol (SDAP), and/or Packet Data Convergence Protocol (PDCP) sublayers of the RAN. The DU may be a logical node hosting Radio Link Control (RLC), Media Access Control (MAC), and Physical (PHY) sublayers of the RAN. The RU may be a physical node that converts radio signals from antennas to digital signals that can be transmitted over the Front Haul to a DU. Because these entities have open protocols and interfaces between them, they can be developed by different vendors.

FIG. 1 illustrates an O-RAN architecture in the related art. RAN functions in the O-RAN architecture may be controlled and optimized by a RAN Intelligent Controller (RIC). The RIC may be a software-defined component that implements modular applications to facilitate the multivendor operability required in the O-RAN system, as well as to automate and optimize RAN operations. As shown in FIG. 1, the RIC may be divided into two types: a non-real-time RIC (Non-RT RIC) 120 and a near-real-time RIC (Near-RT RIC) 130.

The Non-RT RIC 120 may be the control point of a non-real-time control loop and may operate on a timescale greater than 1 second within a Service Management and Orchestration (SMO) framework 110. Its functionalities may be implemented through modular applications called rApps, and may include: providing policy based guidance and enrichment across the A1 interface, which is the interface that enables communication between the Non-RT RIC and the Near-RT RIC; performing data analytics; Artificial Intelligence/Machine Learning (AI/ML) training and inference for RAN optimization; and/or recommending configuration management actions over the O1 interface, which may be the interface that connects the SMO to RAN managed elements (e.g., Near-RT RIC 130, O-RAN Centralized Unit (O-CU) 140,150, O-RAN Distributed Unit (O-DU) 170, etc.).

The Near-RT RIC 130 may operate on a timescale between 10 milliseconds and 1 second and may be coupled with the O-DU 170, the O-CU (disaggregated into the O-CU control plane (O-CU-CP) 140 and the O-CU user plane (O-CU-UP) 150), and an open evolved NodeB (O-eNB) 160 via the E2 interface. The Near-RT RIC 130 may use the E2 interface to control the underlying RAN elements (E2 nodes/network functions (NFs)) over a near-real-time control loop. The Near-RT RIC 130 may monitor, suspend/stop, override, and control the E2 nodes (O-CU 140,150, O-DU 170, and O-eNB 160) via policies. For example, the Near-RT RIC 130 may set policy parameters on activated functions of the E2 nodes. Further, the Near-RT RIC 130 may host xApps to implement functions such as quality of service (QoS) optimization, mobility optimization, slicing optimization, interference mitigation, load balancing, security, etc.

Here, the O-CU-CP 140 and the O-CU-UP 150 may be coupled to each other via the E1 interface, and may be coupled to the O-DU 170 via the F1-c interface and F1-u interface, respectively. Further, the O-RU 180 may be coupled to the O-DU 170 via the Open Fronthaul (OF) Control (C), User (U), Synchronization(S), and Management (M) Planes, and may be coupled to the SMO 110 via the OF M-Plane.

The two types of RICs work together to optimize the O-RAN. For example, the Non-RT RIC 120 may provide the policies, data, and AI/ML models enforced and used by the Near-RT RIC 130 for RAN optimization, and the Near-RT RIC 130 may return policy feedback (i.e., how the policy set by the Non-RT RIC 120 works).

As mentioned above, the Non-RT RIC 120 may be located within the SMO framework 110, which manages and orchestrates RAN elements. Specifically, the SMO 110 may manage and orchestrate what is referred to as the O-Ran Cloud (O-Cloud) 190. The O-Cloud 190 may be a collection of physical RAN nodes that host the RICs, O-CUs, and O-DUs, the supporting software components (e.g., the operating systems and runtime environments), and the SMO 110 itself. In other words, the SMO 110 may manage the O-Cloud 190 from within. The O2 interface may be the interface between the SMO 110 and the O-Cloud 190 it resides in. Through the O2 interface, the SMO 110 may provide infrastructure management services (IMS) and deployment management services (DMS).

In the related art, a O-eNB 160 or underlying RAN elements (NF's) (which may be controlled with SMO 110 over the O1 interface as illustrated in FIG. 1) may be put into a network energy saving (NES) state in order to reduce cost of operation and increase network efficiency. This may include, for example, transferring network load to other candidate cells, or draining traffic on the existing cell before moving to energy saving state.

### SUMMARY

Conventional methods used in the related art may not fully consider how to efficiently analyze the need to activate the NES state, trigger the appropriate elements, and convey the proper information needed to activate NES for the constituent network elements.

According to embodiments, a method, apparatus, and system for Service Management and Orchestration (SMO) network energy saving (NES) using an O1 interface may be provided and may include, receiving, by a SMO of an Open Radio Access Network (O-RAN), NES information from at least one of a O-RAN Distributed Unit (O-DU) and a O-RAN Centralized Unit (O-CU) wherein the NES information includes capability exposing information received from an O-RAN Radio Unit (O-RU); determining, by the SMO based at least in part on the NES information, whether to activate an NES use-case; based on determining to activate the NES use-case, sending, by the SMO, a trigger to activate the NES use-case; and receiving, by the SMO, a first notification indicating a change in a state of the NES use-case.

According to embodiments, a Service Management and Orchestration (SMO) of an Open Radio Access Network (O-RAN) may be provided, and may be configured to: receive network energy saving (NES) information from at least one of an O-RAN Distributed Unit (O-DU) and an O-RAN Centralized Unit (O-CU), wherein the NES information includes capability exposing information received from an O-RAN Radio Unit (O-RU); determine based at least in part on the NES information, whether to activate an NES use-case; based on determining to activate the NES use-case, send a trigger to activate the NES use-case; and receive a first notification indicating a change in a state of the NES use-case.

According to embodiments, at least one non-transitory computer-readable recording medium having recorded thereon instructions executable to implement a method may be provided, the method including: receiving, by a Service Management and Orchestration (SMO) of an Open Radio Access Network (O-RAN), network energy saving (NES) information from at least one of an O-RAN Distributed Unit (O-DU) and an O-RAN Centralized Unit (O-CU), wherein the NES information includes capability exposing information received from an O-RAN Radio Unit (O-RU); determining, by the SMO based at least in part on the NES information, whether to activate an NES use-case; based on determining to activate the NES use-case, sending, by the SMO, a trigger to activate the NES use-case; and receiving, by the SMO, a first notification indicating a change in a state of the NES use-case.

Based on the above embodiments, SMO-based NES approaches using the O1 interface may allow for more optimized energy consumption across the network since decisions automation, as well as more optimized resource allocation.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects and advantages of certain exemplary embodiments of the disclosure will be described below with reference to the accompanying drawings, in which like reference numerals denote like elements, and wherein:

FIG. 1 illustrates an O-RAN architecture according to the related art;

FIG. 2 illustrates a system architecture diagram for O-RAN elements and interfaces according to an embodiment;

FIG. 3 illustrates a general call flow diagram for network energy saving according to an embodiment;

FIG. 4A-5C illustrates a call flow diagram for Cell and Carrier Switch Off/On network energy saving according to an embodiment;

FIG. 5A-5C illustrates a call flow diagram for TRx network energy saving according to an embodiment;

FIG. 6A-6B illustrates a call flow diagram for AI/ML based feasibility analysis by RIC while implementing TRx control according to an embodiment;

FIG. 7A-7C illustrates a call flow diagram for advanced sleep mode network energy saving according to an embodiment;

FIG. 8 is a block diagram of an example data structure for O-DU network energy saving according to an embodiment;

FIG. 9 is a block diagram of an example data structure for O-DU network energy saving using TRx control according to an embodiment;

FIG. 10 is a block diagram of an example data structure for O-DU network energy saving using Advanced Sleep Mode according to an embodiment;

FIG. 11 is a block diagram of an example data structure for O-CU network energy saving according to an embodiment;

FIG. 12 is a flowchart diagram of an example method for activating an network energy saving use-case according to an embodiment;

FIG. 13 is a flowchart diagram of an example method for deactivating network energy saving use-case according to an embodiment;

FIG. 14 is a diagram of an example environment in which systems and/or methods, described herein, may be implemented; and

FIG. 15 is a diagram of example components of a device according to an embodiment.

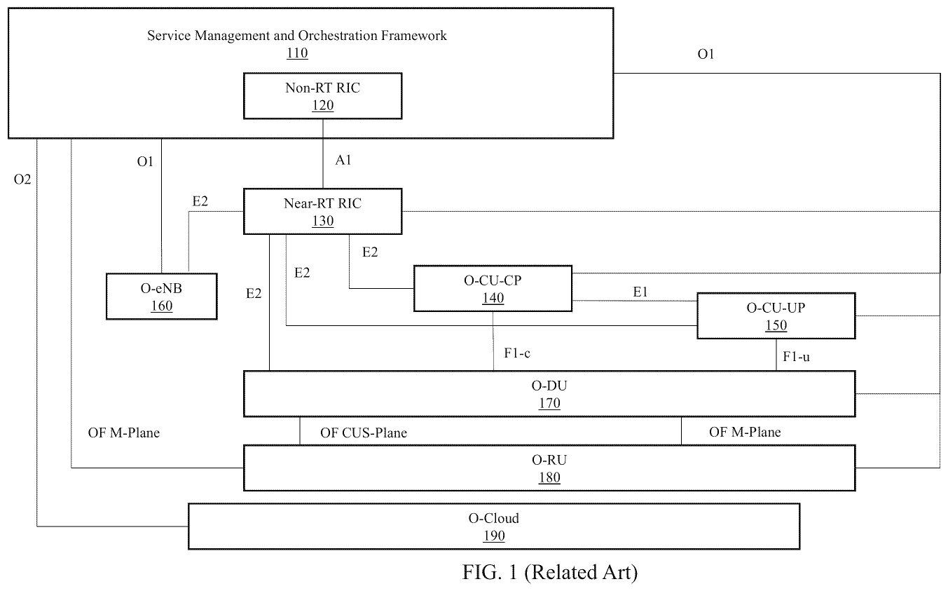

### DETAILED DESCRIPTION

The following detailed description of example embodiments refers to the accompanying drawings. The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

According to embodiments, a method, apparatus, and system for Service Management and Orchestration (SMO) network energy saving (NES) using an O1 interface may be provided and may include, receiving, by a SMO of an Open Radio Access Network (O-RAN), NES information from at least one of a O-RAN Distributed Unit (O-DU) and a O-RAN Centralized Unit (O-CU) wherein the NES information includes capability exposing information received from an O-RAN Radio Unit (O-RU); determining, by the SMO based at least in part on the NES information, whether to activate an NES use-case; based on determining to activate the NES use-case, sending, by the SMO, a trigger to activate the NES use-case; and receiving, by the SMO, a first notification indicating a change in a state of the NES use-case.

Based on the above embodiments, SMO-based NES approaches using the O1 interface may allow for more optimized energy consumption across the network since decisions may be made using real-time data and/or predictive analysis to adjust power profiles, improved automation, as well as more optimized resource allocation.

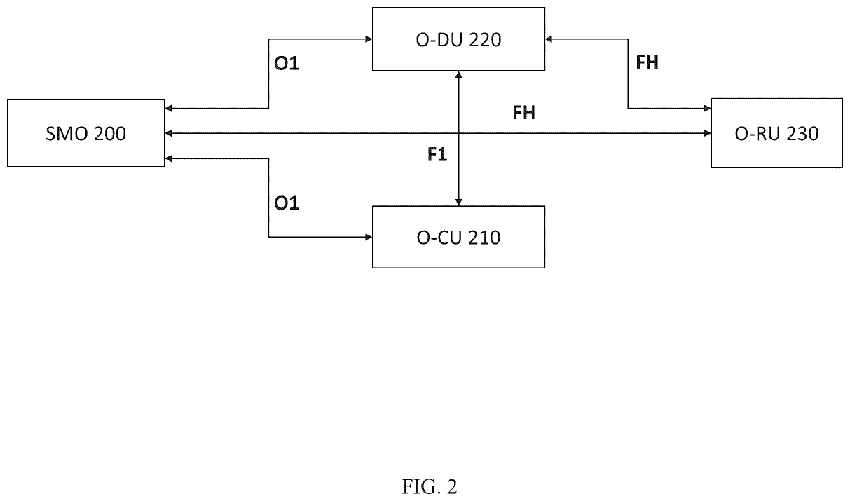

FIG. 2 illustrates a system architecture diagram for O-RAN elements and interfaces according to an embodiment. In particular, Service Management and Orchestration (SMO) 200, O-CU 210, O-DU 220, and O-RU 230 may be provided.

Referring to FIG. 2, SMO 200 may be configured to communicate with O-CU 210 and O-DU 220 via a O1 interface, and vice-versa. O-CU 210 and O-DU 220 may be able to communicate with each other via a F1 interface. O-RU 230 may be able to communicate with SMO 200 and O-DU 220 via fronthaul (FH).

SMO 200 may be responsible for triggering an energy saving use-case to O-DU 220 via the O1 interface, and O-DU 220 in turn may implement the use-case via either a management plane (M-Plane) or a control plane (C-Plane), depending on the specific implementation and use-case.

According to embodiments, SMO 200 could coordinate with the O-DU 220 and O-CU 210, to enable sleep modes/TRx control that does not have an impact on F1 interface (for example, Sleep Mode (SM) #0 and SM #1 with light sleep up to 1 frame (10 ms)). According to embodiments, SMO 200 may implement other sleep modes (e.g., SM #3 and SM #4 with deep and hibernate sleep (10 ms to “x” seconds) using O1 interface.

It should be noted that the F1 interface, according to specifications (such as in the Third Generation Partnership Project (3GPP) may have limitations for providing policy for specifically instructing cells/RF channels to be deactivated/muted/be put to sleep for energy saving use-cases. In this regard, O-CU 210 may be able to provide the timer for cells to be activated or deactivated, but the F1 interface may not inherently be able to differentiate between specific different use-cases.

According to an embodiment, a hierarchical deployment may be provided, wherein O-RU 230 is configured to expose its energy saving capability to O-DU 220 via a fronthaul management plane (FH M-Plane), which may forward the capability to SMO 200 either through an aggregation model, or as a configuration file via the O1 interface.

According to an embodiment, a hybrid deployment may be provided, wherein SMO 200 can directly understand/retrieve the capability from O-RU using a remote procedure call (RPC), e.g., <rpc><get-config>.

According to embodiments, O-DU 220 may be able to expose network energy saving (NES) related parameters to SMO 200. In particular, for example, for a Cell and Carrier Switch Off/On use-case, O-DU 220 may be able to expose energy saving support and associated parameters (to be investigated in O-DU perspective).

According to another embodiment for RF Channel Reconfiguration using a transceiver (TRx) control use-case, O-DU 220 may be able to expose to SMO 200 a list of TRx control configurations (including Antenna array configurations) a list of supported sleep modes (SM) (SM #0, SM #1, SM #2, and SM #4), wake-up duration associated with sleep modes, TRx control antenna configurations transition, as well as other associated parameters (to be investigated in O-DU perspective).

According to another embodiment for Advanced Sleep Mode (ASM) use-case, O-DU 220 may be able to expose to SMO 200 sleep modes (SM #0, SM #1, SM #2, and SM #4), wake-up duration of each sleep mode, and other associated parameters (to be investigated in O-DU perspective).

According to embodiments, O-CU 210 may be able to expose NES related parameters to SMO 200. This may include, but may not necessarily be limited to, RRC configuration related parameters, UE context related parameters, neighbor cell related parameters, and other parameters (to be investigated in O-CU perspective).

### Transceiver (TRx) Control Implementation Using O1 Interface

According to embodiments, SMO 200 may be responsible for providing policies on when to activate the specific transceiver (TRx) control configuration by indicating the mask name. Subsequently, O-DU 220 can activate the same configuration in O-RU 230 by including a respective antenna mask in Section Type 4 Control Plane (ST4 C-Plane) message.

An example table for antenna configurations and antenna masks is illustrated in TABLE 1 below

TABLE 1

| | TRx control | | |
|---|---|---|---|
| Base line | (specific | | |
| antenna | antenna mask) | | |
| config- | activation time | | |
| uration | (T1 to T2) | Mask name | Antenna mask |
| 64T64R | A to B time | Config_32_A | {0 0 0 0 0 0 0 0 0 0 0 0 0 0 |
| | | (32T32R) | 0 0 0 0 0 0 0 0 0 0 0 0 0 0 |
| | | | 0 0 0 0 1 1 1 1 1 1 1 1 1 1 1 |
| | | | 1 1 1 1 1 1 1 1 1 1 1 1 1 1 |
| | | | 1 1 1 1 1 1 1} |
| | C to D time | Config_32_B | {1 1 1 1 1 1 1 1 1 1 1 1 1 1 |
| | | (32T32R) | 1 1 1 1 1 1 1 1 1 1 1 1 1 1 |
| | | | 1 1 1 1 0 0 0 0 0 0 0 0 0 0 0 |
| | | | 0 0 0 0 0 0 0 0 0 0 0 0 0 0 |
| | | | 0 0 0 0 0 0 0} |
| 32T32R | D to E time | Config_16 | {0 0 0 0 0 0 0 0 0 0 0 0 0 0 |
| | | (16T16R) | 0 0 1 1 1 1 1 1 1 1 1 1 1 1 |
| | | | 1 1 1 1} |
| | F to G time | Config_8 | {1 1 1 1 1 1 1 1 0 0 0 0 0 0 |
| | | (8T8R) | 0 0 0 0 0 0 0 0 0 0 0 0 0 0 |
| | | | 0 0 0 0} |

According to an embodiment, O-DU 220 may expose a list of TRx control configuration and sleep modes. Supported sleep modes may include, but are not necessarily limited to, micro sleep, light sleep, deep sleep, hibernation, etc., O-DU 220 may support sending of ST4 C-Plane messages, along with “st4CmdType”, #3 for TRx control, and #4 for Advanced Sleep Mode (ASM; discussed below).

### Advanced Sleep Mode (ASM) Control Implementation by SMO Using O1 Interface

According to embodiments, SMO 200 may provide policies on whether to activate a specific sleep mode. O-DU 220 may accordingly activate the same Sleep Mode in O-RU 230 by including a respective antenna mask in a ST4 C-Plane message.

An example table for sleep modes and the corresponding sleep mode durations and wake-up durations is illustrated in TABLE 2 below.

TABLE 2

| Sleep | | Sleep Mode | Wake-up |
|---|---|---|---|
| Mode | Type | duration | duration |
| SM#0 | Micro sleep (few symbols | Defined | Guaranteed |
| (Sleep | to 1 slot - Wake-up | Defined | Non-Guaranteed |
| Mode | duration is from few | Un-Defined | Guaranteed |
| filed of | symbols to about 1 slot | Un-Defined | Non-Guaranteed |
| ST4 | Light sleep (1 slot to | Defined | Guaranteed |
| message | 10 ms - Wake-up duration | Defined | Non-Guaranteed |
| set to 00) | is from few symbols to | Un-Defined | Guaranteed |
| | about 1 slot) | Un-Defined | Non-Guaranteed |
| SM#1 | Light sleep (1 sub frame | Defined | Guaranteed |
| (Sleep | to 1 frame - Wake-up | Defined | Non-Guaranteed |
| Mode | duration (L micro secs) | Un-Defined | Guaranteed |
| filed of | is from few slots to | Un-Defined | Non-Guaranteed |
| ST4 | about 1 frame (approx.)) | | |
| message | Deep sleep (few frames | Defined | Guaranteed |
| set to 00) | (10 ms to 100 ms) - | Defined | Non-Guaranteed |
| | Wake-up duration (L | Un-Defined | Guaranteed |
| | micro secs) is from few | Un-Defined | Non-Guaranteed |
| | slots to about 1 frame | | |
| | (approx.)) | | |

According to an embodiment, O-DU 220 may expose a list of supported sleep modes. Supported sleep modes may include, but are not necessarily limited to, micro sleep, light sleep, deep sleep, hibernation, etc., O-DU 220 may support sending of ST4 C-Plane messages, along with “st4CmdType” #4 for Advanced Sleep Mode (ASM).

According to an embodiment, a parameter of ru-instance-id may be included in the O1 interface. It may be used to identify the id in NRCellDu which should be equal to ru-instance-id of O-RU 230. ru-instance-id may be used to map NRCellDu and O-RU 230, may be used by SMO 200 and O-DU 220 to locate O-RU 230 where the NES features use-cases are to be employed, and O-DU 220 could use this identify to report the O-RU 230's specific capability (NES) to SMO 200.

According to embodiments, an aggregation yang model could be included in the O1 interface. The SMO 200 may use this model to configure WG4 data model to O-RU 230 via O-DU 220. SMO 200 may instantiate NES feature to O-RU 230 through O-DU 220, where O-DU 220 uses ru-instance-id to distinguish which O-Ru is to be activated with NES. SMO 200 could also perform configuration in FH through this model.

According to embodiments, O-DU 220 and O-RU 230 performance counters may be included. SMO 200 consumes O-DU performance counters via the O1 interface, and O-Du shares performance counters measured at O-RU 230 to SMO 200 via the O1 interface.

Examples of performance counters to be measured at O-DU 220 for TRx Control use-case are given by TABLE 3 and TABLE 4 below:

TABLE 3
Number of TRx control C-plane activation
messages sent Performance Counter Table

| | |
|---|---|
| Measurement Name | OR.ORU.TRXControl.Activation |
| Description | The number of valid outbound TRx control |
| | activation control plane messages. |
| | It is optional counter for O-DU. |
| Collection Method | CC (Cumulative Counter) |
| Condition | Measurement subcounter is incremented by 1 |
| | whenever TRx control configuration is being |
| | activated for energy saving. |
| Measurement Result | Integer number (U64) |
| Measurement Type | OR.ORU.TRXControl.Activation |
| Measurement Object | aggregation (O-RU) |
| Class | |
| Switching | Packet Switched |
| Technology | |
| Generation | 5GS |
| Purpose | Network Operator's Traffic Engineering Community |

TABLE 4
Failure at TRx control activation performance counter table.

| | |
|---|---|
| Measurement Name | OR.ORU.TRXControl.Activation |
| Description | The number of valid outbound TRx control |
| | activation control plane messages. |
| | It is optional counter for O-DU. |
| Collection Method | CC (Cumulative Counter) |
| Condition | Measurement subcounter is incremented by 1 |
| | whenever TRx control configuration is being |
| | activated for energy saving. |
| Measurement Result | Integer number (U64) |
| Measurement Type | OR.ORU.TRXControl.Activation |
| Measurement Object | aggregation (O-RU) |
| Class | |
| Switching | Packet Switched |
| Technology | |
| Generation | 5GS |
| Purpose | Network Operator's Traffic Engineering Community |

According to embodiments, cell activation/deactivation features may be included. SMO 200 may directly activate the Cells in O-DU 220. SMO 200 could configure the cells in O-DU 220, which in turn configures the carrier in O-RU 230, subsequently, SMO 200 activates the cells. According to another case, the SMO 200 may only configure cells that the O-DU 220 serves and their corresponding carriers over O1 interface towards O-DU 220. O-DU 220 may then consequently configure (activate/deactivate) tx/rx-array-carriers over their FH interfaces. It should also be appreciated that according to another embodiment, an O-DU 220 may only activate or deactivate the tx/rx array-carriers in O-RU 230 that belongs to the cells that the O-DU 220 serves.

According to embodiments, a notification framework may be provided. SMO 200 may subscribe to O-CU 210, O-DU 220, O-RU 230 (only in hybrid deployment) via the notification framework. For example, SMO 200 can get notification from O-DU 220 on cell activation/deactivation and tr[x]-array carrier state of O-RU 230.

According to embodiments, odu-id may be provided. Odu-id and ru-instance-id based carrier activation and deactivation, Trx control, and sleep mode implementation may be facilitated accordingly. In WG4 yang models, odu-id may be defined inside [tr]x array carriers. According to embodiments, SMO 200 could use odu-id and ru-instance-id to implement Cell and Carrier Switch Off/On use-case, TRx control use-case, and ASM use-case in specific O-RU 230 through O-DU 220, wherein odu-id could be used as the common reference parameter. SMO 200 could use aggregate models to put to sleep/deactivate the specific carrier/array with the assistance of the corresponding carrier/array name in O-RU yang models.

According to embodiments, the O1 interface may allow for a variety of parameters to be sent to the SMO 200

Particularly, data/parameters which may be sent over O1 may include, but necessarily limited to, user throughputs, power consumption, QoS, User pebeam, current O-Ru configurations, cell configurations, UL/DL delay (min, max and average), transmission and reception window, distributed delay including FH delay between O-DU 220 and O-RU 230, etc.

O-DU 220 capability which can be exposed over O1 interface may further include number of SSB beams supported per TRx control configuration, number of data beams (e.g., PUSCH) per TRx control configuration, beam sweep ranges as a function of number of antenna array elements, or it may be a number of beams per configuration as reported based on O-RU capability.

O-CU related parameters which could be sent may include TRx configuration change by SMO 200 to O-CU 210 and O-DU 220 so that O-CU 210 may be aware of RRC configuration and gNB-DU configuration update is in coordination with O-DU 220. It may also include CSI-RS ports to be updated as per current TRx control configuration (see for example 3GPP TS 38.802-Clause 7.14). It may also include SSB coverage area changes per TRx control configuration-RRC configuration related changes (indicated to O-CU 210 by either near-RT RIC or non-RT RIC). Other O-CU related parameters may also configuration update message between O-CU and O-DU (gNB configuration update and gNB-CU configuration update), and CSI measurement and reporting (both periodic and aperiodic).

Notifications which may be sent over O1 interface may include, but not necessarily limited to, SMO 200 subscribing to notifications, energy saving state (e.g., energySavingState) change notifications, [tx]-array carrier state change notifications, and TRx control configuration changes notifications to O-CU 210 via O1 interface for RRC related changes.

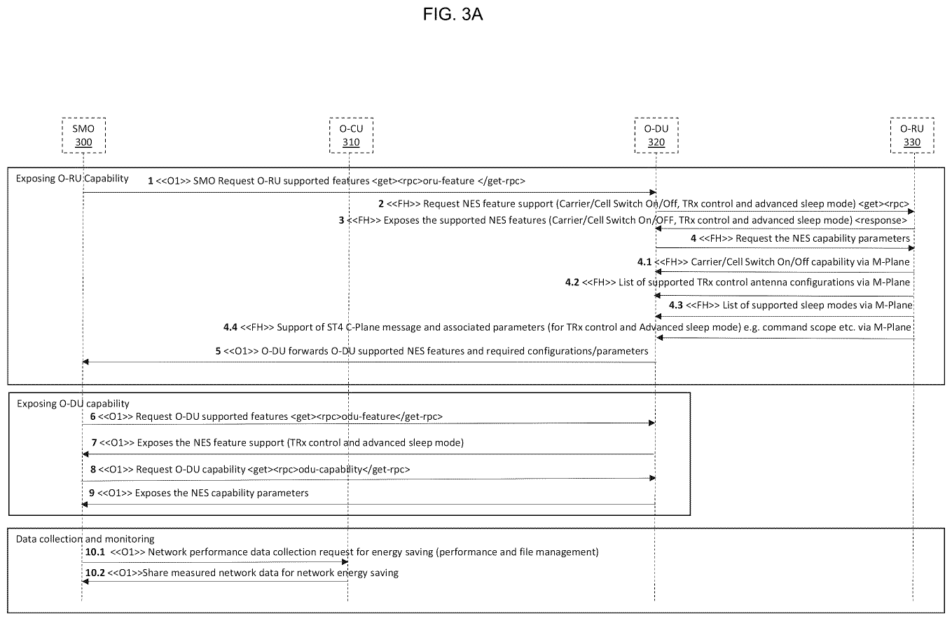

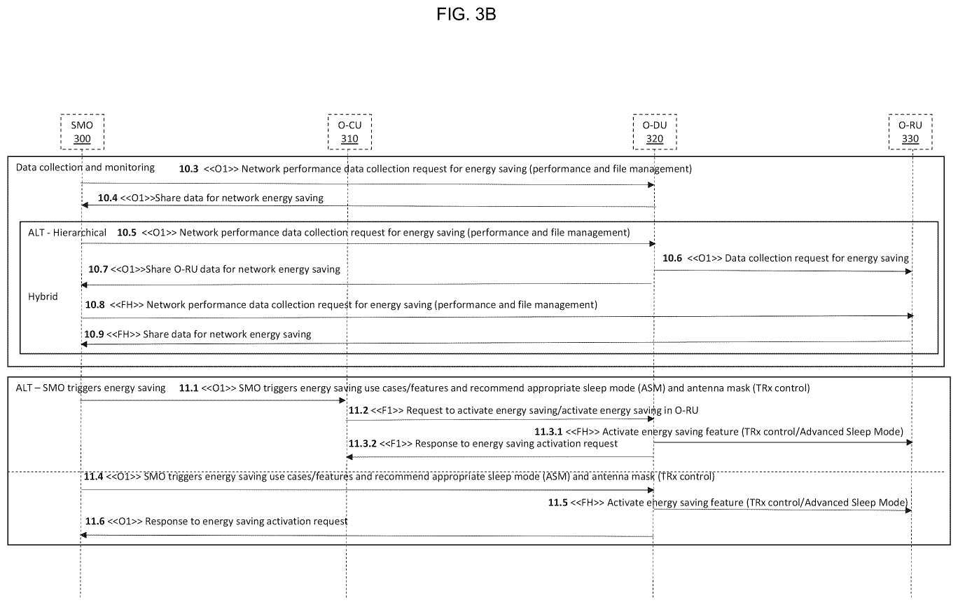

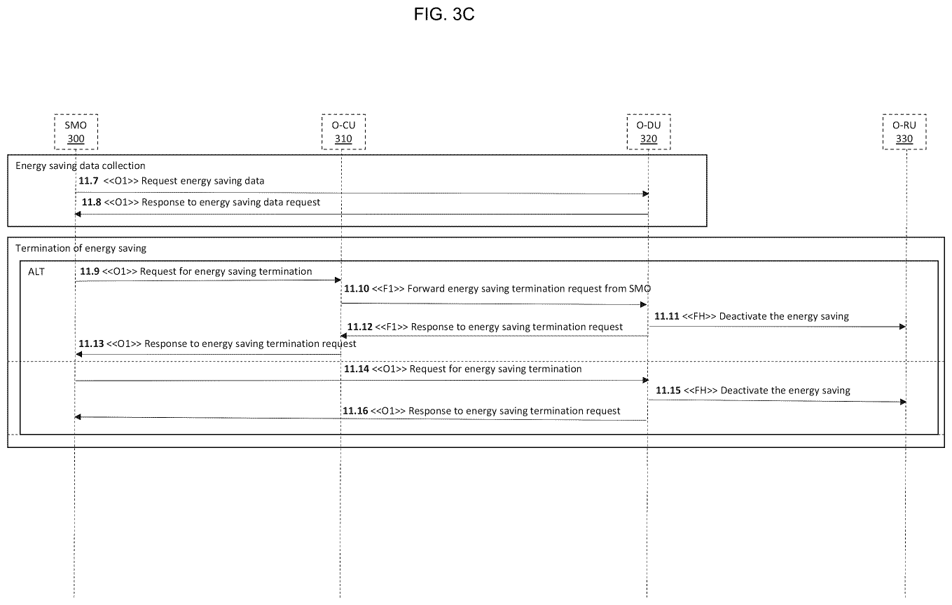

FIG. 3A-3C illustrates a general call flow diagram for network energy saving (NES) according to an embodiment. In particular, SMO 300, O-CU 310, O-DU 320, and O-RU 330 may be provided, which may correspond to the similar entities described in FIG. 2 above.

Referring to FIG. 3A, O-RU 330's capability may firstly be exposed. Constituent steps in the callflow are described as follows.
1—SMO 300 may request O-RU 330's supported features from O-DU 320 using a get rpc call for oru-feature over an O1 interface.
2—O-DU 320 may request NES feature support (such as carrier/cell switch off/on, TRx control, and advanced sleep mode) using a get rpc call over FH interface from O-RU 330.
3—NES features requested in 2 are exposed from O-RU 330 to O-DU 320 in a response.
4—NES capability parameters may be requested by O-DU 320 from O-RU 330 over FH interface. Sub-steps for exposing NES capability parameters may include (depending on the specific use-case):
   4.1—Carrier/Cell Switch On/Off capability may be exposed via M-Plane in FH interface by O-RU 330 to O-DU 320;
   4.2—List of supported TRx control antenna configurations may be exposed via M-Plane in FH interface by O-RU 330 to O-DU 320;
   4.3—List of supported sleep modes may be exposed via M-Plane in FH by O-RU 330 to O-DU 320; and
   4.4—Support of ST4 C-Plane messages and associated parameters (e.g., for TRx control and ASM use-cases, command scope etc.) may be exposed via M-Plane in FH by O-RU 330 to O-DU 320
5—O-DU 320 may forward the O-DU supported NES features and required configurations/parameters back to SMO 300.

Following steps 1-5 illustrated in FIG. 3A, O-DU capability may be exposed as follows.
6—O-DU supported features may be requested by SMO 300 from O-DU 320 over a get rpc call for odu-feature over O1 interface.
7—O-DU 320 may expose the NES supported features (for TRx and ASM use-cases) over O1 interface.
8—O-DU capability may be requested by SMO 300 from O-DU 320 over a get rpc call for odu-capability over O1 interface.
9—NES capability parameters may be exposed by O-DU 320 to SMO 300 over O1 interface.

Following steps 6-9 illustrated in FIG. 3A, data collection and monitoring may take place for SMO 300 (as illustrated in FIG. 3A-3B)
10.1—A request for network performance data collection for energy saving (Performance and file management) may be requested by SMO 300 from O-CU 310 over O1 interface.
10.2—The measured network data requested in 10.1 may be shared by O-CU 310 to SMO 300 over the O1 interface.
10.3—A request for network performance data collection for energy saving (Performance and file management) may be requested by SMO 300 from O-DU 320 over O1 interface.
10.4—The measured network data requested in 10.3 may be shared by O-DU 320 to SMO 300 over the O1 interface.

In the case of hierarchical deployment, network data from O-RU for energy saving may be obtained as follows (illustrated in FIG. 3B).
10.5—A request for network performance data collection for energy saving (Performance and file management) may be requested by SMO 300 from O-DU 320 over O1 interface.
10.6—Data collection request for energy saving is sent to O-RU 330.
10.7—The measured network data (which is the O-RU data for network energy saving in 10.6) may be shared by O-DU 320 to SMO 300 over the O1 interface.

Alternatively, if the deployment is instead a hybrid deployment, an alternative call flow to steps 10.5 through 10.7 is as follows:
10.8—Network performance data collection request for energy saving (performance and file management) is sent from SMO 300 directly to O-RU 330 over FH interface.
10.9—O-RU 330 shares the data for network energy saving requested in step 10.8 to SMO 300 over FH interface.

The SMO 300 may decide to trigger energy saving based on the network energy saving data collected in steps above. Accordingly, in a first case, the SMO 300 may communicate with O-CU to trigger the NES use-case as follows:
11.1—SMO 300 triggers NES use-case/features and recommends appropriate sleep mode (ASM) and antenna mask (TRx control) and sends trigger to O-CU 310 over O1 interface.
11.2—O-CU 310 requests O-DU 320 to activate energy saving/activate energy saving in O-RU 330 over F1 interface.
11.3.1—O-DU 320 instructs O-RU 330 to activate the energy saving feature (either TRx control or ASM) over FH interface.
11.3.2—Response to energy saving activation request is sent by O-DU 320 to O-CU 310 over F1 interface.

In the second case, SMO 300 may trigger the NES use-case with O-DU 320. Steps may be as follows:
11.4—SMO 300 triggers NES use-case/features and recommends appropriate sleep mode (ASM) and antenna mask (TRx control) to O-DU 320 over O1 interface.
11.5—Energy saving features are activated (TRx control/ASM) based on request sent from O-DU 320 to O-RU 330 over FH interface.
11.6—Response to energy saving activation request is sent by O-DU 320 to SMO 300 over O1 interface.

Referring now to FIG. 3C, energy saving data collection may be performed by SMO 300 in order to monitor the status of the energy saving from NES use-case implementation.

At step 11.7, SMO 300 requests energy saving data from o-DU 320 over O1 interface.

At step 11.8, a response to energy saving data request is sent by O-DU 320 to SMO 300 over O1 interface.

SMO 300 may determine based on the energy saving data received in step 11.8 that energy saving should be terminated. In a first case, the request may be sent to O-CU 310 by SMO 300, steps as follows:

At step 11.9, a request for energy saving termination may be sent from SMO 300 to O-CU 310 over O1 interface.

At step 11.10 the energy saving termination request is forwarded by O-CU 310 to O-Du 320 over F1 interface.

At step 11.11, the energy saving deactivation request is sent by O-Du 320 to O-RU 330 over FH interface.

At step 11.12, a response to energy saving termination request is sent from O-DU 320 to O-CU 310 over F1 interface.

At step 11.13, the response to the energy saving termination request is received by SMO 300 from O-CU 310 over O1 interface.

In the second case, the request for energy saving termination request is sent directly to O-DU 320 from SMO 300. Steps are as follows:

At step 11.14, the request for energy saving termination request is sent by SMO 300 to O-DU 320 over O1 interface.

At step 11.15, the request to deactivate energy saving is sent by O-DU 320 to O-RU 330 over FH interface.

At step 11.16, the response to energy saving termination request is sent by O-Du 320 to SMO 300 over O1 interface.

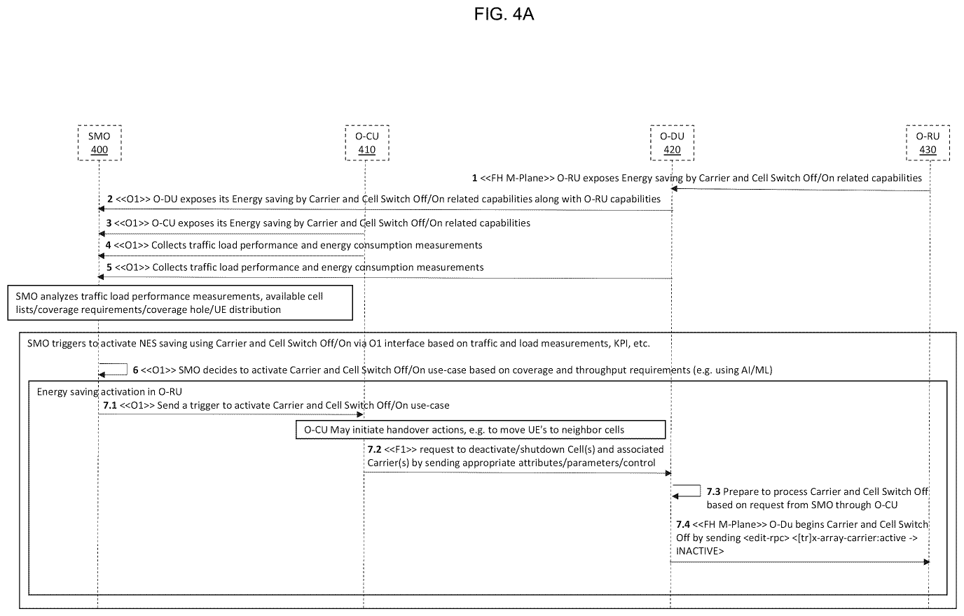

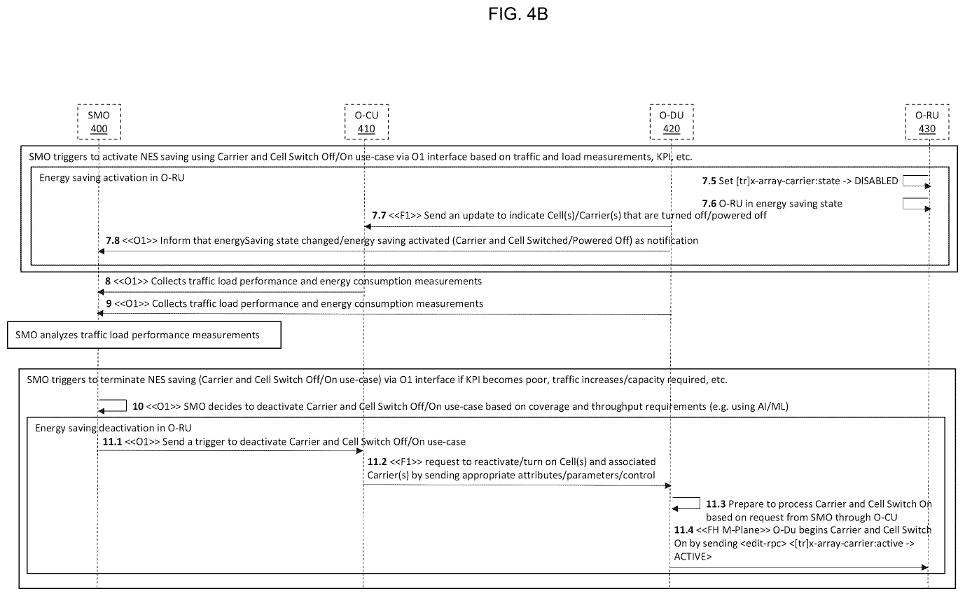

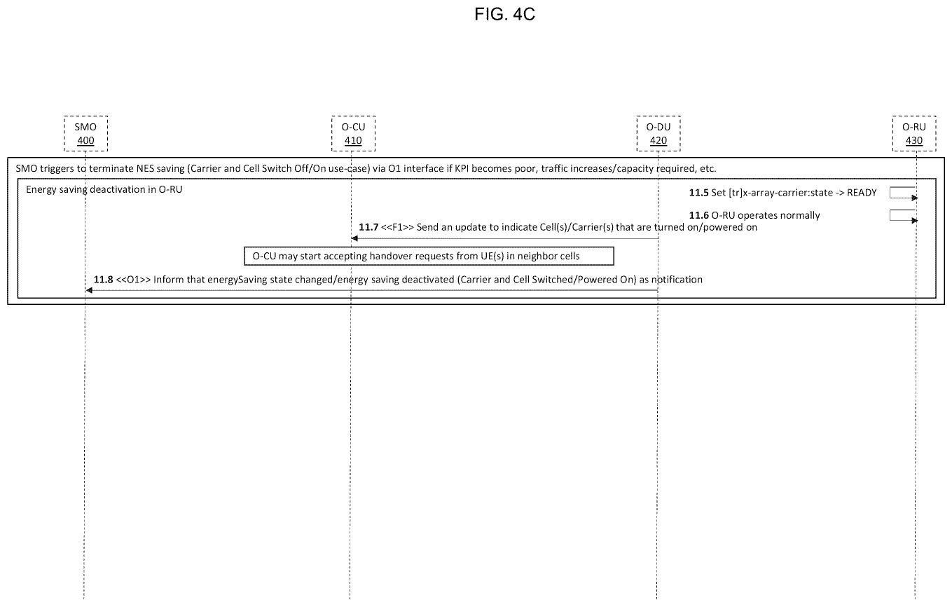

It should be appreciated that FIG. 3 is a more generalized call flow diagram and intended to cover multiple use-cases, and more specific call flow for the specific use-cases are discussed in FIG. 4-FIG. 7 as discussed below.

FIG. 4A-4C illustrates a call flow diagram for Cell and Carrier Switch Off/On network energy saving according to an embodiment. SMO 400, O-CU 410, O-DU 420, and O-RU 430 are provided, and may be similar to their counterparts above.

At step 1, the O-RU 430 may expose energy saving capabilities (e.g., NES related information) including Cell and Carrier switch off/on related capabilities to O-DU 420, over FH M-Plane interface.

At step 2, the O-DU 420 may expose its energy saving by Cell and Carrier switch off/on related capabilities along with O-RU capabilities to SMO 400 over O1 interface.

At step 3, the O-CU 410 may expose its energy saving by Cell and Carrier switch off/on related capabilities to SMO 400 over O1 interface.

At step 4, SMO 400 may collect traffic load performance and energy consumption measurements from O-CU 410 over O1 interface.

At step 5, SMO 400 may collect traffic load performance and energy consumption measurements from O-DU 420 over O1 interface.

Thereafter, SMO 400 may analyze traffic load performance measurements, available cell lists/coverage requirements/coverage hole/UE distribution in order to determine whether or not to activate an NES use-case.

At step 6, the SMO 400 may decide to trigger to activate NES using the Cell and Carrier switch off/on via the O1 interface (based on traffic and load measurements, Key Performance Indicator (KPI), etc.) over O1 interface. This may also be based on coverage and throughput requirements, and determined, for example, using artificial intelligence/machine learning (AI/ML).

Energy saving activation may be performed in O-RU 430 as follows.

At step 7.1, SMO 400 may send a trigger to O-CU 410 to activate Cell and Carrier switch off/on use-case over O1 interface. O-CU 410 may decide to initiate handover actions (for example, moving a UE to a neighbor cell in view of the cell switch off).

At step 7.2, O-CU 410 may forward the request to deactivate/shutdown cell(s) and associated carrier(s) by sending appropriate attributes/parameters/controls to O-DU 420 over F1 interface.

At step 7.3, O-DU 420 may prepare to process Cell and Carrier switch off based on request from SMO 400 through O-CU 410.

At step 7.4, O-DU 420 may send a edit-rpc call to O-RU 430 to begin Cell and Carrier switch off: e.g., <edit-rpc><[tr] x-array-carrier: active->INACTIVE>

Referring now to FIG. 4B, at step 7.5, O-RU 430 may set [tr] x-array-carrier: state->DISABLED.

At step 7.6, O-RU 430 may be in an energy saving state.

At step 7.7, O-DU 420 may send an update to O-CU 410 over the F1 interface to indicate cell(s)/carrier(s) are turned off/powered off.

At step 7.8, O-DU 420 may inform SMO 400 that energysaving state has changed/energy saving activated (e.g., Cell and Carrier switched are powered off) as a notification over O1 interface.

At step 8, SMO 400 may collect traffic load performance and energy consumption measurements from O-CU 410 over O1 interface.

At step 9, SMO 400 may collect traffic load performance and energy consumption measurements from O-Du 420 over O1 interface.

The SMO 400 may analyze traffic load performance measurements. At step 10, the SMO may decide to deactivate Cell and Carrier switch off/on use-case based on coverage and throughput requirements (e.g., using AI/ML), for example, based on KPI being too poor, traffic increasing, capacity being required, etc. This may be performed over O1 interface.

At step 11.1, energy saving deactivation in O-RU may be triggered by SMO 400 and sent to O-CU 410 over O1 interface to deactivate the Cell and Carrier switch off/on use-case.

At step 11.2, a request to reactivate/turn on cell(s) and associated carrier(s) by sending appropriate attributes/parameters/control is sent from O-CU 410 to O-DU 420 over F1 interface.

At step 11.3, the O-Du 420 may prepare to process Cell and Carrier switch on based on request sent from SMO 400 through O-CU 410.

At step 11.4, the O-DU 420 may begin Cell and Carrier switch on by sending an edit rpc call to O-RU 430 over FH M-Plane interface, that is, <edit-rpc>< [tr] x-array-carrier: active->ACTIVE>

At step 11.5, O-RU 430 may sent [tr] x-array-carrier: state->Ready.

At step 11.6, O-RU 430 may be back to normal operation.

At step 11.7, O-DU 420 may send an update to O-CU 410 over F1 interface to indicate that cell(s)/carrier(s) are turned on/powered on. O-CU 410 may thereafter start accepting handover requests from UE(s) in neighbor cells.

At step 11.8, O-DU 420 may send a notification to SMO 400 over O1 interface to inform that energySaving state changed/energy saving is deactivated (Cell and Carrier switched/powered on).

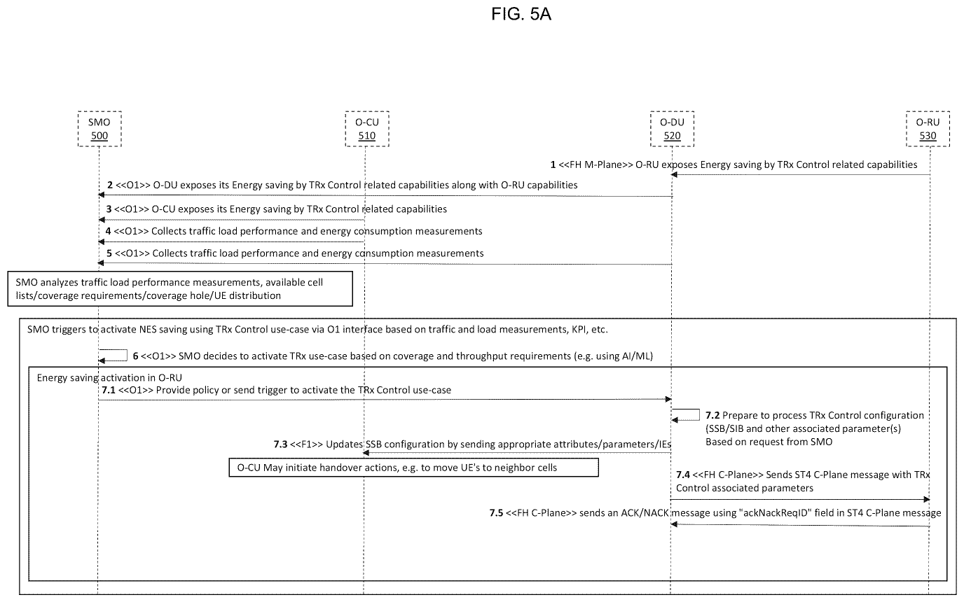

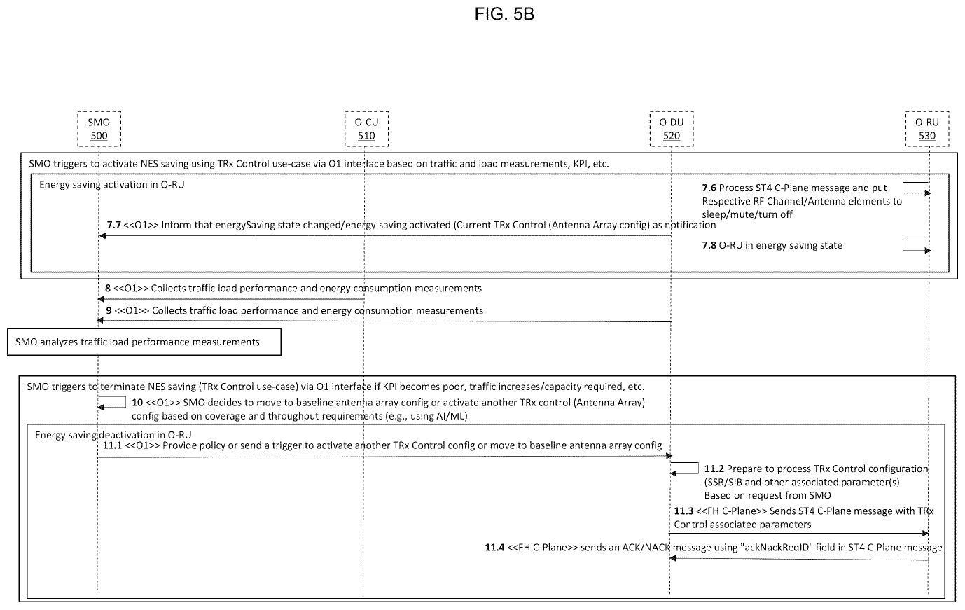

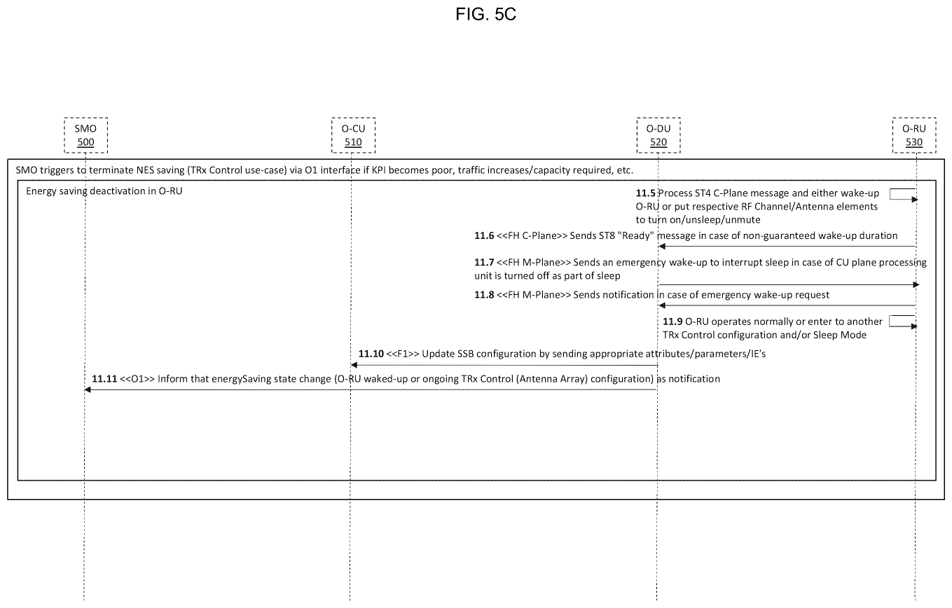

FIG. 5A-5C illustrates a call flow diagram for TRx network energy saving according to an embodiment.

SMO 500, O-CU 510, O-DU 520, and O-RU 530 are provided, and may be similar to their counterparts above.

At step 1, the O-RU 530 may expose energy saving capabilities (e.g., NES related information) including TRx control related capabilities to O-DU 520, over FH M-Plane interface.

At step 2, the O-DU 520 may expose its energy saving by TRx control related capabilities along with O-RU capabilities to SMO 500 over O1 interface.

At step 3, the O-CU 510 may expose its energy saving by TRx control related capabilities to SMO 500 over O1 interface.

At step 4, SMO 500 may collect traffic load performance and energy consumption measurements from O-CU 510 over O1 interface.

At step 5, SMO 500 may collect traffic load performance and energy consumption measurements from O-DU 520 over O1 interface.

Thereafter, SMO 500 may analyze traffic load performance measurements, available cell lists/coverage requirements/coverage hole/UE distribution in order to determine whether or not to activate an NES use-case.

At step 6, the SMO 500 may decide to trigger to activate NES using TRx control via the O1 interface (based on traffic and load measurements, Key Performance Indicator (KPI), etc.) over O1 interface. This may also be based on coverage and throughput requirements, and determined, for example, using artificial intelligence/machine learning (AI/ML).

Energy saving activation may be performed in O-RU 530 as follows.

At step 7.1, SMO 500 may provide a policy, or send a trigger to O-CU 510 to activate TRx control use-case over O1 interface.

At step 7.2, O-DU 520 may prepare to process TRx control configurations (synchronization signal block/system information block) (SSB/SIB) and other associated parameters based on the request from SMO 500.

At step 7.3, O-DU 520 may send an update of the SSB configuration to O-CU 510 over F1 interface by sending appropriate parameters/attributes/information elements (IE)'s. O-CU 510 may initiate handover actions (e.g., move UE's to neighbor cells).

At step 7.4, O-DU 520 may send a ST4 C-Plane message with TRx control associated parameters to O-DU 530 over FH C-Plane interface.

At step 7.5, O-RU 530 may send an ACK/NACK message using “ackNackReqID” field in the ST4 C-Plane message over FH C-Plane Interface to O-DU 520.

Referring now to FIG. 5B, at step 7.6 O-RU 530 may process ST4 C-Plane message from and put the respective RF channel/Antenna elements to sleep/mute/turn off.

At step 7.7, O-DU 520 may inform SMO 500 that energysaving state changed/energy saving activated (Current TRx control/antenna array configuration) as a notification over O1 interface.

At step 7.8, O-RU 530 may be in an energy saving state.

At step 8, SMO 500 may collect traffic load performance and energy consumption measurements from O-CU 510 over O1 interface.

At step 9, SMO 500 may collect traffic load performance and energy consumption measurements from O-DU 520 over O1 interface.

The SMO 500 may analyze traffic load performance measurements. At step 10, the SMO 500 may decide to move to baseline antenna array configuration or activate another TRx control (Antenna array) configuration based on coverage and throughput requirements (e.g., using AI/ML), for example, based on KPI being too poor, traffic increasing, capacity being required, etc. This may be performed over O1 interface.

At step 11.1, SMO 500 may provide a policy or send a trigger to O-DU 520 over O1 interface to activate another TRx control configuration or move to the baseline antenna array configuration.

At step 11.2, O-DU 520 may prepare to process TRx control configuration (SSB/SIB and other associated parameters(s) based on the request from SMO in step 11.1.

At step 11.3, O-DU 520 may send a ST4 C-Plane message with TRx control associated parameters to O-RU 520 over FH C-Plane interface.

At step 11.4, O-RU 530 may send an ACK/NACK message using “ackNackReqID’ field in ST4 C-Plane message.

Referring now to FIG. 5C, at step 11.5, O-RU 530 may process the ST4 C-Plane message from 11.3 and either wake-up O-RU 530 or put the respective RF channel/antenna elements to turn on/unsleep/unmute.

At step 11.6, a ST8 “ready” message may be sent from O-RU 530 to O-DU 520 in case of non-guaranteed wake-up duration over FH C-Plane. Interface.

At step 11.7, O-DU 520 may send an emergency wake-up to O-RU 530 over FH M-Plane interface to interrupt sleep in case CU plane processing unit is turned off as part of sleep.

At step 11.8, O-RU 530 may send a notification to O-DU 520 over FH M-Plane interface in case of emergency wake-up request.

At step 11.9, the O-RU 530 may operate normally or enter to another TRx Control configuration and/or sleep mode.

At step 11.10, O-DU 520 updates the SSB configuration at O-CU 510 by sending appropriate attributes/parameters/IE's over F1 interface.

At step 11.11, O-DU 520 may inform SMO 500 over O1 interface notification that energysaving state changed (e.g., O-RU 530 woke-up, or ongoing TRx Control (Antenna Array) configuration).

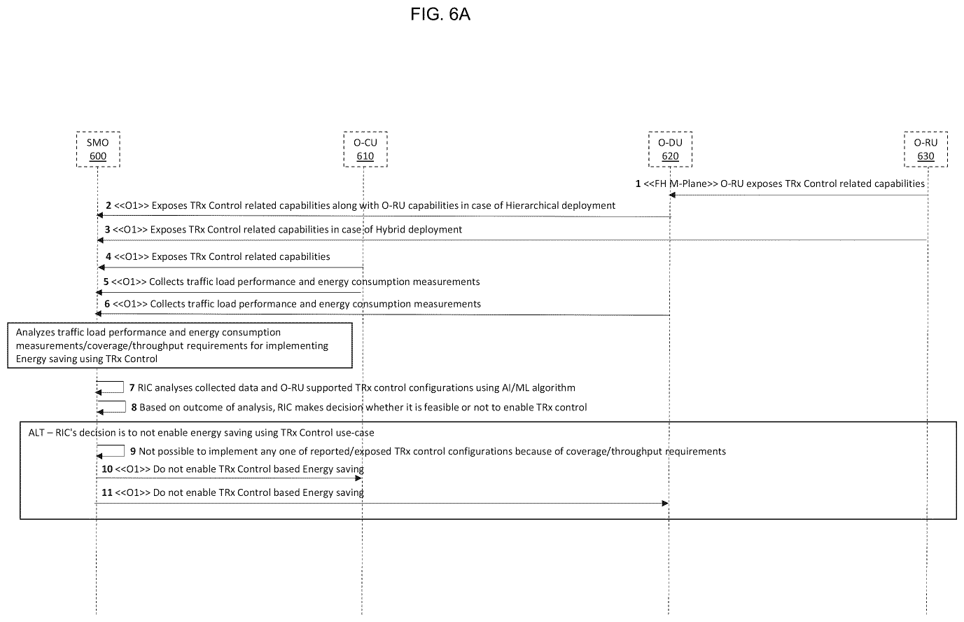

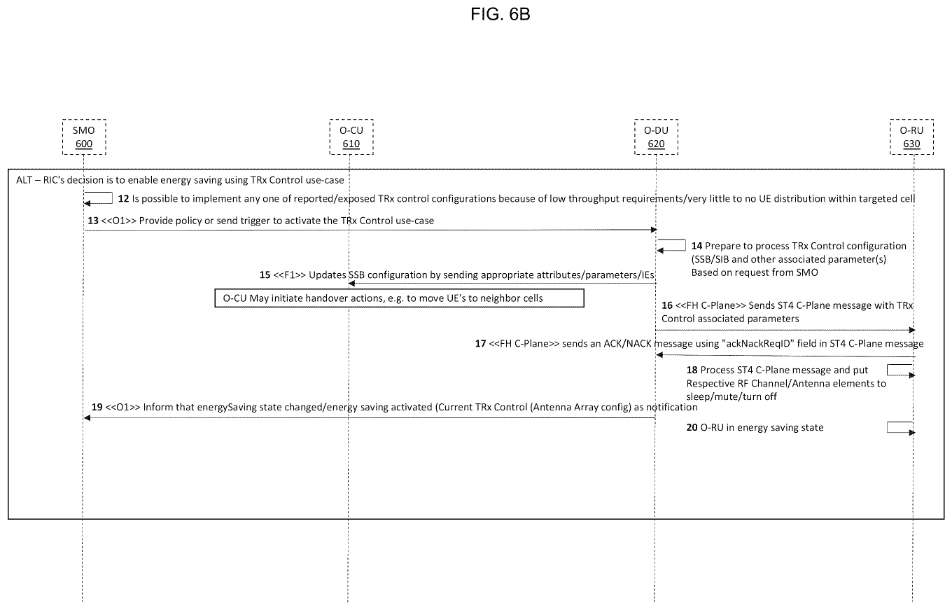

FIG. 6A-6B illustrates a call flow diagram for AI/ML based feasibility analysis by RIC while implementing TRx control according to an embodiment. SMO 600, O-CU 610, O-DU 620, and O-RU 630 are provided, and may be similar to their counterparts above. It should be appreciated that callflow in FIG. 6 may share similarities with FIG. 5, in view that the use-case is similar, except that additional AI/ML algorithm-related steps may be included.

Referring to FIG. 6A, at step 1, O-RU 630 may expose TRx Control related capabilities to O-DU 620 over FH M-Plane interface.

At step 2, O-DU 620 may expose TRx Control related capabilities along with O-RU capabilities to SMO 600 in the case of hierarchical deployment, over O1 interface.

As an alternative to step 2, in step 3, O-RU 630 may directly expose TRx Control related capabilities to SMO 600 in the case of hybrid deployment, over O1 interface.

At step 4, O-CU 610 may expose TRx control related capabilities to SMO 600 over O1 interface.

At step 5, traffic load performance and energy consumption measurements are collected by SMO 600 from O-CU 610 over O1 interface.

At step 6, traffic load performance and energy consumption measurements are collected by SMO 600 from O-CU 610 over O1 interface.

The SMO 600 may analyze traffic load performance and energy consumption measurements/coverage/throughput requirements for implementing energy saving using TRx Control.

At step 7, the RIC may analyze collected data including O-RU supported TRx control configurations using an AI/ML algorithm.

At step 8, based on the analysis result from step 7, the RIC may make a decision whether it is feasible or not to enable TRx control.

In the case that the RIC's decision is to not enable energy saving using a TRx Control use-case, at step 9, the SMO 600 may recognize it is not possible to implement any one of the reported/exposed TRx control configurations because of coverage/throughput requirements. Accordingly, at step 10 and 11, SMO 600 will send a notification to O-CU 610 and O-DU 620 respectively over O1 interface, to not enable any TRx Control based energy saving.

Referring now to FIG. 6B, in the case where the RIC decision is to enable energy saving using TRx Control use-case, at step 12, SMO 600 recognizes it is possible to implement any one of reported/exposed TRx control configurations because of low throughput requirements/very little to no UE distribution within targeted cell. The following steps to activate TRx control may be similar to use-case illustrated in FIG. 5

At step 13, SMO 600 may provide a policy, or send a trigger to O-CU 610 to activate TRx control use-case over O1 interface.

At step 14, O-DU 620 may prepare to process TRx control configurations (synchronization signal block/system information block) (SSB/SIB) and other associated parameters based on the request from SMO 600.

At step 15, O-DU 620 may send an update of the SSB configuration to O-CU 610 over F1 interface by sending appropriate parameters/attributes/information elements (IE)'s. O-CU 610 may initiate handover actions (e.g., move UE's to neighbor cells).

At step 16, O-DU 620 may send a ST4 C-Plane message with TRx control associated parameters to O-DU 630 over FH C-Plane interface.

At step 17, O-RU 630 may send an ACK/NACK message using “ackNackReqID” field in the ST4 C-Plane message over FH C-Plane Interface to O-DU 620.

At step 18 O-RU 630 may process ST4 C-Plane message from and put the respective RF channel/Antenna elements to sleep/mute/turn off.

At step 19, O-DU 620 may inform SMO 600 that energysaving state changed/energy saving activated (Current TRx control/antenna array configuration) as a notification over O1 interface.

At step 20, O-RU 630 may be in an energy saving state.

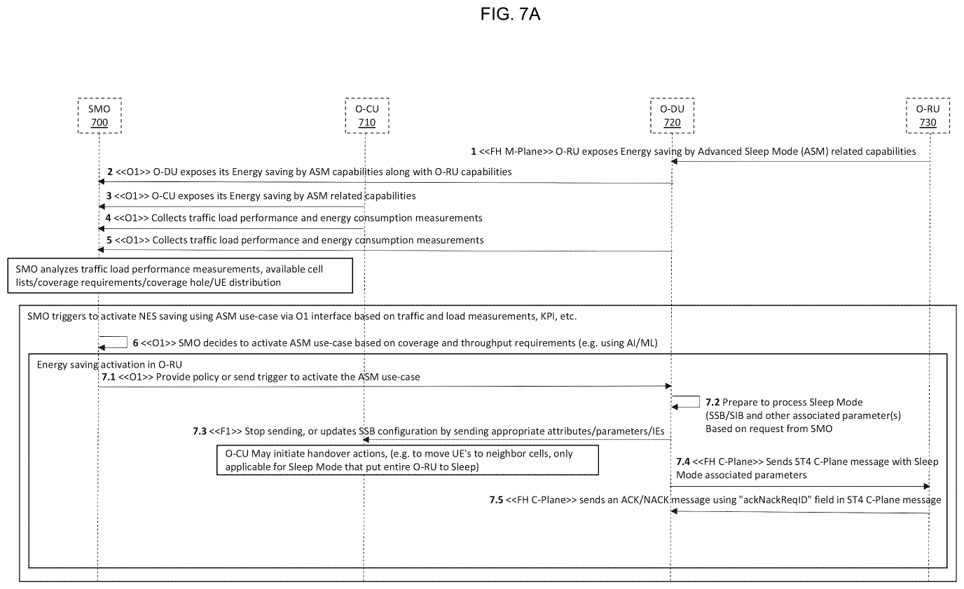

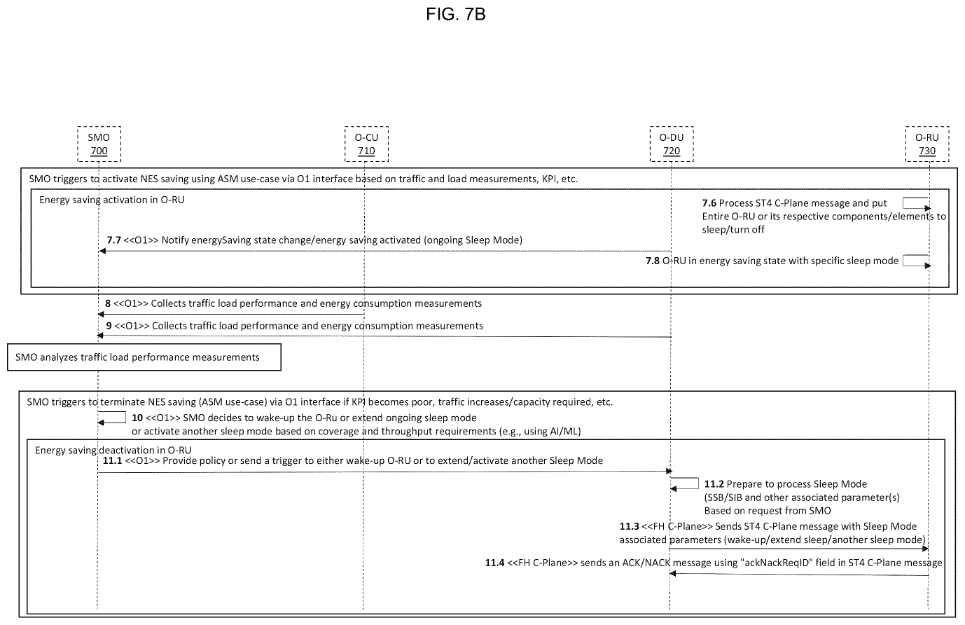

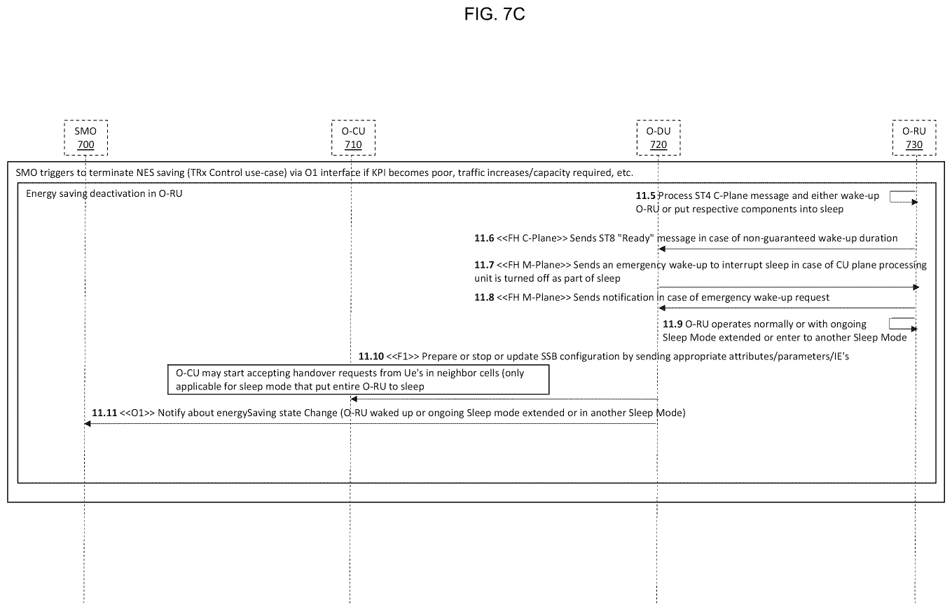

FIG. 7A-7C illustrates a call flow diagram for advanced sleep mode (ASM) network energy saving according to an embodiment. SMO 700, O-CU 710, O-DU 720, and O-RU 730 are provided, and may be similar to their counterparts above.

At step 1, O-RU 730 may expose energy saving by ASM related capabilities to O-DU 720 over FH M-Plane interface.

At step 2, O-DU 720 may expose its energy saving by ASM capabilities along with O-RU capabilities to SMO 700 over O1 interface.

At step 3, O-CU 710 may expose its energy saving by ASM related capabilities to SMo 700 over O1 interface.

At step 4, SMO 700 may collect traffic load performance and energy consumption measurements from O-CU 710 over O1 interface.

At step 5, SMO 700 may collect traffic load performance and energy consumption measurements from O-Du 720 over O1 interface.

The SMO 700 may analyze traffic load performance measurements, available cell lists/coverage requirements/coverage hole/UE distribution. At step 6, SMO 700 may decide to activate ASM use-case based on coverage and throughput requirements (e.g., using AI/ML) over O1 interface (for example, based on traffic and load measurements, KPI, etc.)

At step 7.1, SMO 700 may provide a policy or send a trigger to O-DU 720 over O1 interface to activate the ASM use-case.

At step 7.2, O-DU 720 may prepare to process sleep mode (SSB/SIB and other associated parameter(s) based on the request from the SMO 700.

At step 7.3, O-DU 720 may either stop sending to O-CU 710 over F1 interface, or

update a SSB configuration at O-CU 710 over F1 interface by sending appropriate attributes/parameters/IE's. O-Cu 710 may initiate handover actions (e.g., to move UE's to neighbor cells, only applicable for Sleep Mode which puts entire O-RU 730 to Sleep).

At step 7.4, O-DU 720 may send a ST4 C-Plane message with Sleep Mode associated parameters to O-RU over FH C-Plane interface.

At step 7.5, O-DU 720 sends an ACK/NACK message using “ackNackReqID” field in ST4 C-Plane message to O-RU 730 over FH C-Plane interface.

Referring now to FIG. 7B, at step 7.6, O-RU 730 may process the ST4 C-Plane message from step 7.4, and put the entire O-Ru or its respective components/elements to sleep/turn off.

At step 7.7, O-DU 720 may notify SMO 700 over O1 interface that energySaving state changed/energy saving activated (ongoing Sleep Mode).

At step 8, SMO 700 collects traffic load performance and energy consumption measurements from O-CU 710 over O1 interface.

At step 9, SMO 700 collects traffic load performance and energy consumption measurements from O-DU 720 over O1 interface.

SMO 700 may analyze the load performance measurements received in steps 8 and 9, and decide in step 10 to terminate NES saving over O1 interface. Particularly, SMO 700 may decide to wake up O-RU 730 or extend the ongoing sleep mode, or activate another sleep mode based on coverage and throughput requirements (e.g., using AI/ML), for example, e, based on KPI becoming poor, traffic increasing/capacity required.

At step 11.1, energy saving deactivating may be initiated by SMO 700 by providing a policy or sending a trigger to O-DU 720 to either wake-up O-RU 730 or extend/activate another Sleep Mode over O1 interface.

At step 11.2, O-DU 720 may prepare to process sleep mode (SSB/SIB and other associated parameter(s) based on request from SMO 700.

At step 11.3, O-DU 720 sends a ST4 C-Plane message with Sleep Mode associated parameters (wake-up/extend sleep/another sleep mode) to O-RU 730 over FH C-Plane interface.

At step 11.4, O-RU 730 sends an ACK/NACK message using “ackNackReqID” field in ST4 C-Plane message over FH C-Plane interface.

Referring now to FIG. 7C, at step 11.5, O-RU 730 may process the ST4 C-Plane message from step 11.3 and either wake-up the O-RU 730 or put respective components into the appropriate sleep mode.

At step 11.6, a ST8 “ready” message may be sent from O-RU 730 to O-DU 720 in case of non-guaranteed wake-up duration over FH C-Plane. Interface.

At step 11.7, O-DU 720 may send an emergency wake-up to O-RU 730 over FH M-Plane interface to interrupt sleep in case CU plane processing unit is turned off as part of sleep.

At step 11.8, O-RU 730 may send a notification to O-DU 720 over FH M-Plane interface in case of emergency wake-up request.

At step 11.9, the O-RU 730 may operate normally or enter to another TRx Control configuration and/or sleep mode.

At step 11.10, O-DU 720 may prepare or stop or updates the SSB configuration at O-CU 710 by sending appropriate attributes/parameters/IE's over F1 interface. O-CU 710 may start accepting handover requests from UE's in neighbor cells (only applicable for sleep mode which puts entire O-RU to sleep).

At step 11.11, O-DU 720 may inform SMO 700 over O1 interface notification that energysaving state changed (e.g., O-RU 730 woke-up, or ongoing sleep mode extended or in another sleep mode).

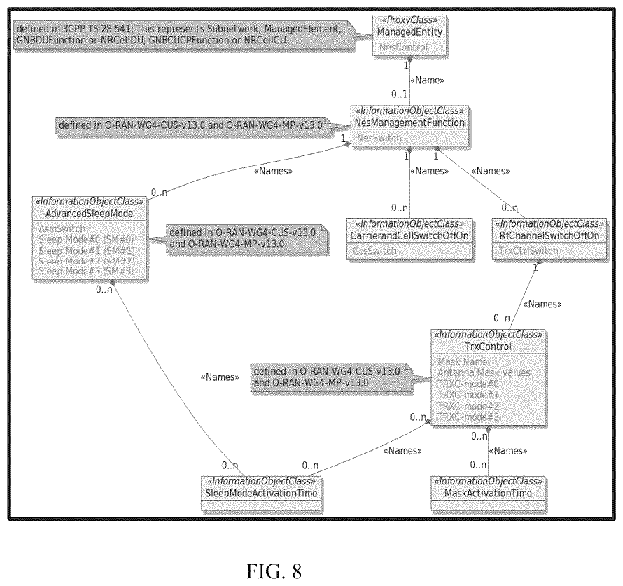

FIG. 8 is a block diagram of an example data structure for O-DU network energy saving according to an embodiment. The example data structure may be generically used for all use-cases.

NesControl attribute may be defined in a “ManagedEntity”. This “ManagedEntity” may represent subnetwork, “ManagedElement”, gnodeB Distribution unit function/New Radio Cell Distributed Unit (DU) (“GNBDUFunction/NRCellDU”), gnodeB Centralized Unit Control Plane Function (“GNBCUCPFunction”) and “NRCellCU”.

A use-case object “NesManagementFunction” may be defined under the “ManagedEntity” in which “NesSwitch” attribute may be defined. Further, the “NesManagementFunction” may have use-case object “AdvancedSleepMode” with attributes like list of AdvanceSleepMode” indicating various possible sleep modes;

“CarrierandCellSwitchOffon” use-case object may be defined under “NesManagementFunction” in which “CcsSwitch” attribute may be defined.

“RfChannelSwitchOffOn” use-case object may be defined under “NesManagementFunction” in which “TrxCtrlSwitch” attribute may be defined. Further, the “RfChannelSwitchOffOn” object may have sub use-case object “TrxControl” with attribute like list of supported TRx control configurations.

According to embodiments, existing 3GPP functions “SleepModeActivationTime” may be reused for the “AdvancedSleepMode” and TRx Control use-case. Further, the “MaskActivationTime” may be reused for the TRx Control use-case.

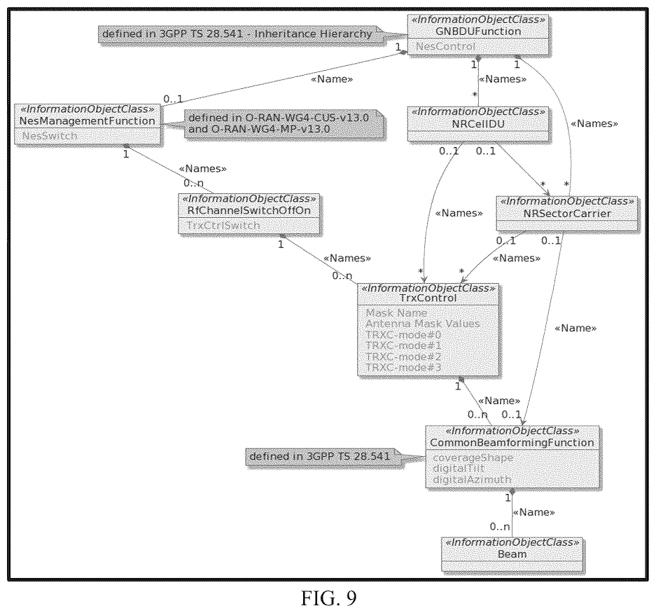

FIG. 9 is a block diagram of an example data structure for O-DU network energy saving using TRx control according to an embodiment.

“NesControl” attribute is defined in “GNBDUFunction” to provision SMO to enable/disable.

A child node “NesManagementFunction” is defined under “GNBDUFunction”, in which “NesSwitch” attribute is defined to facilitate “On/Off” functionality for NES.

“RrChannelSwitchOffOn” use-case object defined under “NesManagementFunction”, which has sub use-case object “TrxControl” with attributes like list of supported TRx control configurations and associated sleep modes.

“TrxControl” is mapped to “NRSectorCarrier” and “NRCellDU” as the [tr] x-arrays in O-RU mapped with [tr] x-array-carriers, which are then mapped with 3GPP objects NRSectorCarrier and NRCellDU.

Existing 3GPP functions “Beam” and “CommonBeamformingFunction” can be reused for TRx Control use-case.

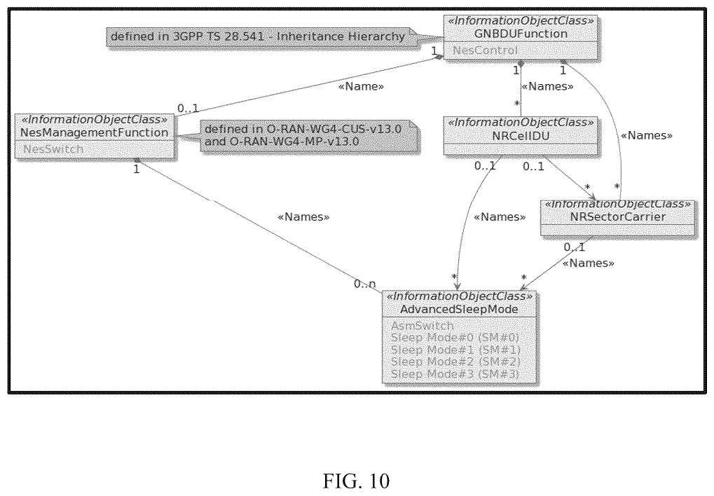

FIG. 10 is a block diagram of an example data structure for O-DU network energy saving using Advanced Sleep Mode according to an embodiment.

“NesControl” attribute is defined in “GNBDUFunction” to provision SMO to enable/disable

A child node “NesManagementFunction” is defined under “GNBDUFunction”, in which “NesSwitch” attribute is defined to facilitate “On/Off” functionality for NES

“AdvancedSleepMode” use-case object defined under “NesManagementFunction”, which has various supported sleep modes as attributes.

“AdvancedSleepMode” is mapped to “NRSectorCarrier” and “NRCellDU” as the [tr]x-arrays in O-RU mapped with [tr] x-array-carriers, which are then mapped with 3GPP objects NRSectorCarrier and NRCellDU

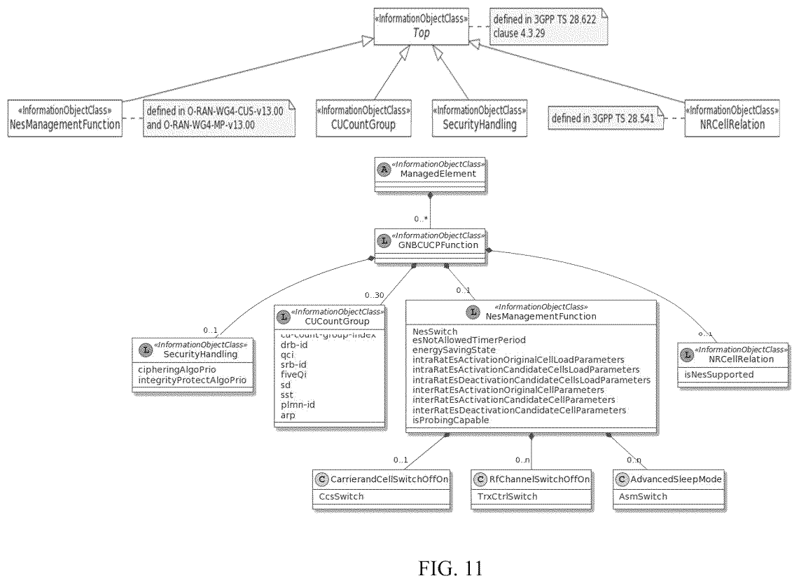

FIG. 11 is a block diagram of an example data structure for O-CU network energy saving according to an embodiment. The example data structure may be used generically for all above-described use-cases.

“GNBCUPFunction” may be defined under “ManagedElement”. Further, use-case object “NesManagementFunction” may be defined under the “GNBCUPFunction” with attributes like “NesSwitch”;

Use-case object “CUCountGroup” may be defined under the “GNBCUPFunction” with attributes like cu-count-group-index;

Use-case object “SecurityHandling” may be defined under the “GNBCUPFunction” with attributes like “cipheringAlgoPrio”;

Use-case object “NRCellRelation” may be defined under the “GNBCUPFunction” with attributes like “isNesSupported”;

“CarrierandCellSwitchOffon” use-case object may be defined under “NesManagementFunction” in which “CcsSwitch” attribute may be defined;

“RfChannelSwitchOffOn” use-case object may be defined under “NesManagementFunction” in which “TrxCtrlSwitch” attribute may be defined;

“AdvanceSleepMode” use-case object may be defined under “NesManagementFunction” in which “AsmSwitch” attribute may be defined.

It should be appreciated that the above-described data models in FIG. 8-11 are examples, and that differences in structure and variable names may be made by a person skilled in the art depending on the specific implementation use-case.

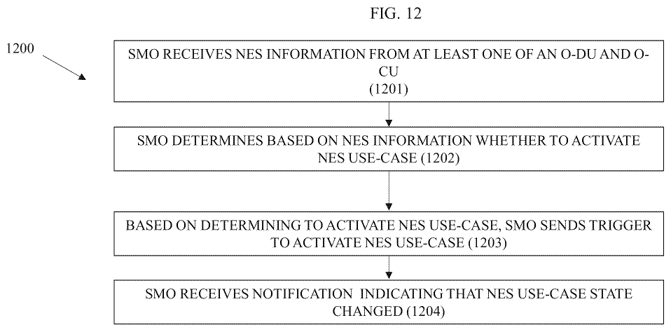

FIG. 12 is a flowchart diagram of an example method for activating an network energy saving use-case according to an embodiment.

At operation 1201, a SMO of an O-RAN may receive NES information from at least one of an O-DU and an O-CU, including capability exposing information from the O-RU. The NES information may also include NES use-cases related capabilities, traffic load performance, and energy consumption measurements.

At operation 1202, the SMO may determine, based at least in part on the NES information, whether to activate an NES use-case.

At operation 1203, based on determining to activate the NES use-case, the SMO may send a trigger to activate the NES use-case.

If the NES use-case is Cell and Carrier Switch Off/On the trigger is sent to the O-CU, wherein upon receiving the trigger, the O-CU is configured to send a request to the O-DU to request deactivation of cells and associated carriers, wherein upon receiving the request, the O-DU is configured to process Cell and Carrier Switch Off to an O-RAN radio unit (O-RU) via a management plane (M-Plane) to set the O-RU into an energy saving state, wherein the O-RU is set into the energy saving state by disabling an associated array-carrier.

If the NES use-case is TRx control, the trigger is sent to the O-DU, wherein upon receiving the trigger, the O-DU is configured to send attributes and parameters to the O-CU to update a Synchronization Signal Block (SSB) configuration, and send a Section type 4 Control Plane (ST4 C-Plane) message with TRx control associated parameters to the O-RU to set the O-RU into an energy saving state, wherein the O-RU is set into the energy saving state by turning off the appropriate RF Channels and Antenna Elements based on the ST4 C-Plane message. In this use-case, determining whether to activate an NES use-case in operation 1202 may further be based on using an artificial intelligence (AI) or machine learning (ML) algorithm, and based on determining to not activate the NES use-case, a further step of sending, by the SMO, a message to the O-CU and the O-DU indicating to not activate TRx control may be included to replace operations 1203 and 1204.

If the NES use-case is Advanced Sleep Mode (ASM), the trigger is sent to the O-DU, wherein upon receiving the trigger, the O-DU is configured to either stop sending configuration updates to the O-CU, or send attributes and parameters to the O-CU to update a SSB configuration, and send a ST4 C-Plane message with Sleep Mode associated parameters to the O-RU to set the O-RU into an energy saving state, wherein the O-RU is set into the energy saving state by putting to sleep the O-RU or components of the O-RU based on the ST4 C-Plane message.

At operation 1204, the SMO may receive a first notification indicating a change in a state of the NES use-case.

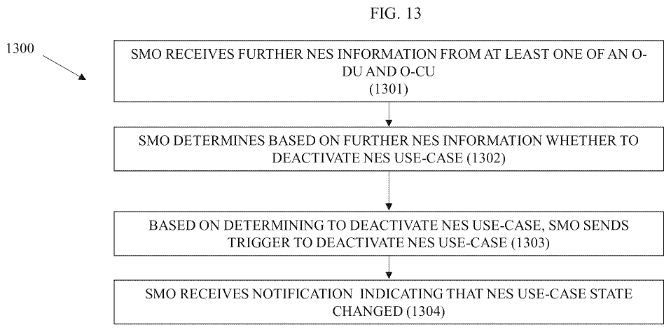

FIG. 13 is a flowchart diagram of an example method for deactivating network energy saving use-case according to an embodiment.

At operation 1301, the SMO may receive further NES information from at least one of the O-DU and the O-CU. This may include traffic load performance and energy consumption information.

At operation 1302, the SMO may determine based at least in part on the further NES information, whether to deactivate the NES use-case.

At operation 1303, based on determining to deactivate the NES use-case, the SMO may send a trigger to the O-CU to deactivate the NES use-case.

At operation 1303, the SMO may receive a second notification indicating a change in the state of the NES use-case.

Based on the above embodiments, SMO-based NES approaches using the O1 interface may allow for more optimized energy consumption across the network since decisions automation, as well as more optimized resource allocation.

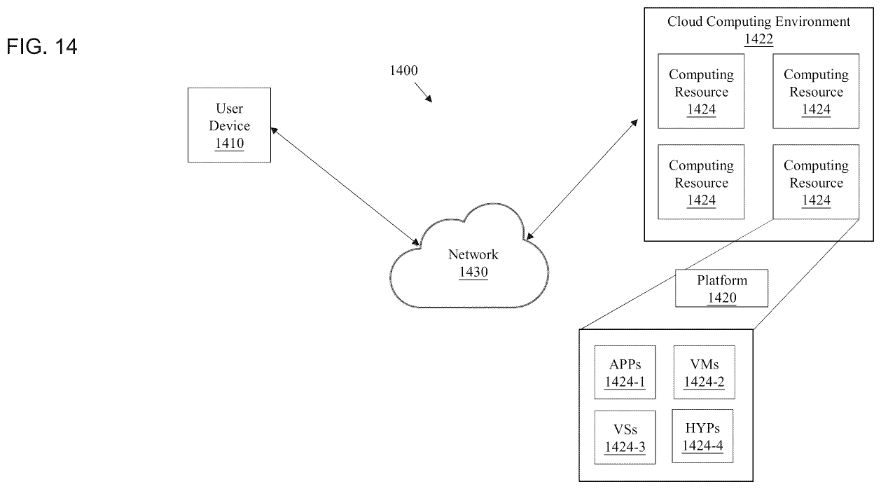

FIG. 14 is a diagram of an example environment 1400 in which systems and/or methods, described herein, may be implemented. As shown in FIG. 14, environment 1400 may include a user device 1410, a platform 1420, and a network 1430. Devices of environment 1400 may interconnect via wired connections, wireless connections, or a combination of wired and wireless connections. In embodiments, any of the functions and operations described with reference to FIGS. 2-13 above may be performed by any combination of elements illustrated in FIG. 14.

User device 1410 includes one or more devices capable of receiving, generating, storing, processing, and/or providing information associated with platform 1420. For example, user device 1410 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 1410 may receive information from and/or transmit information to platform 1420.

Platform 1420 includes one or more devices capable of receiving, generating, storing, processing, and/or providing information. In some implementations, platform 1420 may include a cloud server or a group of cloud servers. In some implementations, platform 1420 may be designed to be modular such that certain software components may be swapped in or out depending on a particular need. As such, platform 1420 may be easily and/or quickly reconfigured for different uses.

In some implementations, as shown, platform 1420 may be hosted in cloud computing environment 1422. Notably, while implementations described herein describe platform 1420 as being hosted in cloud computing environment 1422, in some implementations, platform 1420 may not be cloud-based (i.e., may be implemented outside of a cloud computing environment) or may be partially cloud-based.

Cloud computing environment 1422 includes an environment that hosts platform 1420. Cloud computing environment 1422 may provide computation, software, data access, storage, etc., services that do not require end-user (e.g., user device 1410) knowledge of a physical location and configuration of system(s) and/or device(s) that hosts platform 1420. As shown, cloud computing environment 1422 may include a group of computing resources 1424 (referred to collectively as “computing resources 1424” and individually as “computing resource 1424”).

Computing resource 1424 includes one or more personal computers, a cluster of computing devices, workstation computers, server devices, or other types of computation and/or communication devices. In some implementations, computing resource 1424 may host platform 1420. The cloud resources may include compute instances executing in computing resource 1424, storage devices provided in computing resource 1424, data transfer devices provided by computing resource 1424, etc. In some implementations, computing resource 1424 may communicate with other computing resources 1424 via wired connections, wireless connections, or a combination of wired and wireless connections.

As further shown in FIG. 14, computing resource 1424 includes a group of cloud resources, such as one or more applications (“APPs”) 1424-1, one or more virtual machines (“VMs”) 1424-2, virtualized storage (“VSs”) 1424-3, one or more hypervisors (“HYPs”) 1424-4, or the like.

Application 1424-1 includes one or more software applications that may be provided to or accessed by user device 1410. Application 1424-1 may eliminate the need to install and execute the software applications on user device 1410. For example, application 1424-1 may include software associated with platform 1420 and/or any other software capable of being provided via cloud computing environment 1422. In some implementations, one application 1424-1 may send/receive information to/from one or more other applications 1424-1, via virtual machine 1424-2.

Virtual machine 1424-2 includes a software implementation of a machine (e.g., a computer) that executes programs like a physical machine. Virtual machine 1424-2 may be either a system virtual machine or a process virtual machine, depending upon use and degree of correspondence to any real machine by virtual machine 1424-2. A system virtual machine may provide a complete system platform that supports execution of a complete operating system (“OS”). A process virtual machine may execute a single program, and may support a single process. In some implementations, virtual machine 1424-2 may execute on behalf of a user (e.g., user device 1410), and may manage infrastructure of cloud computing environment 1422, such as data management, synchronization, or long-duration data transfers.

Virtualized storage 1424-3 includes one or more storage systems and/or one or more devices that use virtualization techniques within the storage systems or devices of computing resource 1424. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 1424-4 may provide hardware virtualization techniques that allow multiple operating systems (e.g., “guest operating systems”) to execute concurrently on a host computer, such as computing resource 1424. Hypervisor 1424-4 may present a virtual operating platform to the guest operating systems and may manage the execution of the guest operating systems. Multiple instances of a variety of operating systems may share virtualized hardware resources.

Network 1430 includes one or more wired and/or wireless networks. For example, network 1430 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 14 are provided as an example. In practice, there may be additional devices and/or networks, fewer devices and/or networks, different devices and/or networks, or differently arranged devices and/or networks than those shown in FIG. 14. Furthermore, two or more devices shown in FIG. 14 may be implemented within a single device, or a single device shown in FIG. 14 may be implemented as multiple, distributed devices. Additionally, or alternatively, a set of devices (e.g., one or more devices) of environment 1400 may perform one or more functions described as being performed by another set of devices of environment 1400.

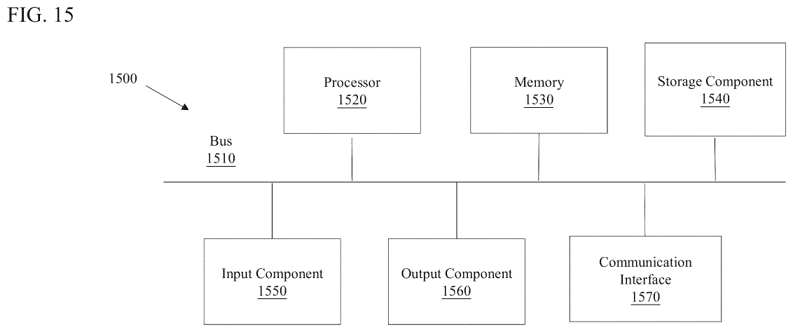

FIG. 15 illustrates an embodiment of a device 1500. As shown in FIG. 15, the device 1500 processor 1510, a memory 1520, a storage component 1530, an input component 1540, an output component 1550, a communication interface 1560, and a bus 1570.

The processor 1510, as used herein, means any type of computational circuit that may comprise hardware elements and software elements. The processor 1510 may be embodied as a multi-core processor, a single core processor, or a combination of one or more multi-core processors and/or one or more single core processors, a distributed processing system, or the like. The processor 1510 may be a Central Processing Unit (CPU) a graphics processing unit (GPU), an accelerated processing unit (APU), an application-specific integrated circuit (ASIC), or another type of processing component.

Memory 1520 includes a non-transitory computer readable medium. Memory 1520 includes a random-access memory (RAM), a read only memory (ROM), and/or another type of dynamic or static storage device (e.g., a flash memory, a magnetic memory, and/or an optical memory) that stores information and/or instructions for use by processor 1510. The memory 1520 comprises machine-readable instructions which are executable by the processor 1510. These machine-readable instructions when executed by the processor 1510 cause the processor 1510 to perform one or more method steps of an embodiment described above.

Storage component 1530 stores information and/or software related to the operation and use of the device 1500. For example, storage component 1530 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 1540 is configured to receive information, such as user input. For example, the input component 1540 may include, but not be limited to, a touch screen display, a keyboard, a keypad, a mouse, a button, a switch, and/or a microphone. Additionally, or alternatively, the input component 1540 may include a sensor for sensing information (e.g., a global positioning system (GPS), an accelerometer, a gyroscope, and/or an actuator).

Output component 1550 is configured to provide output information from the device 1500. For example, the output component 1550 may be, but not limited to, a display, a speaker, instructions to an external device, and/or one or more light-emitting diodes (LEDs).

Communication interface 1560 is an interface that provides a communication connection to other devices, such as external devices and internal devices. The connection by the communication interface 1560 can be a wired connection, a wireless connection, or a combination of wired and wireless connections, and can be a direct connection or an indirect connection via a communication network that exists between the device 1500 and other devices. In other words, the standard of the communication interface 1560 is not limited.

The bus 1570 acts as an interconnect between the processor 1510, the memory 1520, the storage component 1530, the input component 1540, the output component 1550, and the communication interface 1560 of the device 1500. The bus 1570 may include a wired interconnection or a wireless interconnection.

The number and arrangement of components shown in FIG. 15 are provided as an example. In practice, device 1500 may include additional components, fewer components, different components, or differently arranged components than those shown in FIG. 15. Additionally, or alternatively, a set of components (e.g., one or more components) of device 1500 may perform one or more functions described as being performed by another set of components of device 1500. Further, one or more method steps described in any of the embodiments may be performed utilizing a plurality of devices 1500 in communication with one another.

In embodiments, any one of the operations or processes of FIGS. 2-13 may be implemented by or using any one of the elements illustrated in FIGS. 14 and 15. It is understood that other embodiments are not limited thereto, and may be implemented in a variety of different architectures (e.g., bare metal architecture, any cloud-based architecture or deployment architecture such as Kubernetes, Docker, OpenStack, etc.).

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a microservice(s), module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Various further respective aspects and features of embodiments of the present disclosure may be defined by the following items:

Item [1]: A method, including: receiving, by a Service Management and Orchestration (SMO) of an Open Radio Access Network (O-RAN), network energy saving (NES) information from at least one of an O-RAN Distributed Unit (O-DU) and an O-RAN Centralized Unit (O-CU), wherein the NES information includes capability exposing information received from an O-RAN Radio Unit (O-RU); determining, by the SMO based at least in part on the NES information, whether to activate an NES use-case; based on determining to activate the NES use-case, sending, by the SMO, a trigger to activate the NES use-case; and receiving, by the SMO, a first notification indicating a change in a state of the NES use-case.

Item [2]: The method according to Item [1], further including: receiving, by the SMO, further NES information including traffic load performance and energy consumption measurements from at least one of the O-DU and the O-CU; determining, by the SMO based at least in part on the further NES information, whether to deactivate the NES use-case; based on determining to deactivate the NES use-case, sending, by the SMO, a trigger to the O-CU to deactivate the NES use-case; and receiving, by the SMO, a second notification indicating a change in the state of the NES use-case.

Item [3]: The method according to any one of Items [1]-[2], wherein the NES use-case is Cell and Carrier Switch Off/On; the trigger is sent to the O-CU; based on receiving the trigger, the O-CU is configured to send a request to the O-DU to request deactivation of cells and associated carriers; based on receiving the request, the O-DU is configured to process Cell and Carrier Switch Off to an O-RAN radio unit (O-RU)O-RU via a management plane (M-Plane) to set the O-RU into an energy saving state; and the O-RU is configured to be set into the energy saving state by disabling an associated array-carrier.

Item [4]: The method according to any one of Items [1]-[2], the NES use-case is TRx control, wherein the trigger is sent to the O-DU; based on receiving the trigger, the O-DU is configured to send attributes and parameters to the O-CU to update a Synchronization Signal Block (SSB) configuration, and send a Section type 4 Control Plane (ST4 C-Plane) message with TRx control associated parameters to the O-RU to set the O-RU into an energy saving state; and the O-RU is set into the energy saving state by turning off appropriate RF Channels and Antenna Elements based on the ST4 C-Plane message.

Item [5]: The method according to Item [4], wherein the determining whether to activate the NES use-case is further based on using an Artificial Intelligence (AI) or machine learning (ML) algorithm; and the method further includes, based on determining to not activate the NES use-case, sending, by the SMO, a message to the O-CU and the O-DU indicating to not activate TRx control.

Item [6]: The method according to any one of Items [1]-[2], wherein the NES use-case is Advanced Sleep Mode (ASM); the trigger is sent to the O-DU; based on receiving the trigger, the O-DU is configured to either stop sending configuration update(s) to the O-CU, or send attributes and parameters to the O-CU to update a SSB configuration, and send a ST4 C-Plane message with Sleep Mode associated parameters to the O-RU to set the O-RU into an energy saving state; and the O-RU is set into the energy saving state by putting the O-RU to sleep or putting components of the O-RU to sleep based on the ST4 C-Plane message.

Item [7]: The method according to any one of Items [1]-[6], wherein the NES information includes NES use-case(s) related capabilities, traffic load performance, and energy consumption measurements.

Item [8] A Service Management and Orchestration (SMO) of an Open Radio Access Network (O-RAN) configured to: receive network energy saving (NES) information from at least one of an O-RAN Distributed Unit (O-DU) and an O-RAN Centralized Unit (O-CU), wherein the NES information includes capability exposing information received from an O-RAN Radio Unit (O-RU); determine based at least in part on the NES information, whether to activate an NES use-case; based on determining to activate the NES use-case, send a trigger to activate the NES use-case; and receive a first notification indicating a change in a state of the NES use-case.

Item [9]: The SMO according to Item [8], further configured to: receive further NES information including traffic load performance and energy consumption measurements from at least one of the O-DU and the O-CU; determine based at least in part on the further NES information, whether to deactivate the NES use-case; based on determining to deactivate the NES use-case, send a trigger to the O-CU to deactivate the NES use-case; and receive a second notification indicating a change in the state of the NES use-case.

Item [10]: The SMO according to any one of Items [8]-[9], wherein: the NES use-case is Cell and Carrier Switch Off/On; the trigger is sent to the O-CU; based on receiving the trigger, the O-CU is configured to send a request to the O-DU to request deactivation of cells and associated carriers; based on receiving the request, the O-DU is configured to process Cell and Carrier Switch Off to an O-RU via a management plane (M-Plane) to set the O-RU into an energy saving state; and the O-RU is configured to be set into the energy saving state by disabling an associated array-carrier.

Item [11]: The SMO according to any one of Items [8]-[9], wherein: the NES use-case is TRx control, wherein the trigger is sent to the O-DU; based on receiving the trigger, the O-DU is configured to send attributes and parameters to the O-CU to update a Synchronization Signal Block (SSB) configuration, and send a Section type 4 Control Plane (ST4 C-Plane) message with TRx control associated parameters to the O-RU to set the O-RU into an energy saving state; and the O-RU is set into the energy saving state by turning off appropriate RF Channels and Antenna Elements based on the ST4 C-Plane message.

Item [12]: The SMO according to Item [11], wherein: the SMO is configured to determine whether to activate the NES use-case further based on using an Artificial Intelligence (AI) or machine learning (ML) algorithm; and the SMO is further configured to, based on determining to not activate the NES use-case, send a message to the O-CU and the O-DU indicating to not activate TRx control.

Item [13]: The SMO according to any one of Items [8]-[9], wherein: the NES use-case is Advanced Sleep Mode (ASM); the trigger is sent to the O-DU; based on receiving the trigger, the O-DU is configured to either stop sending configuration update(s) to the O-CU, or send attributes and parameters to the O-CU to update a SSB configuration, and send a ST4 C-Plane message with Sleep Mode associated parameters to the O-RU to set the O-RU into an energy saving state; and the O-RU is set into the energy saving state by putting the O-RU to sleep or putting components of the O-RU to sleep based on the ST4 C-Plane message.

Item [14]: The SMO according to any one of Items [8]-[13], wherein the NES information includes NES use-case(s) related capabilities, traffic load performance, and energy consumption measurements.

Item [15]: At least one non-transitory computer-readable recording medium having recorded thereon instructions executable to implement a method including: receiving, by a Service Management and Orchestration (SMO) of an Open Radio Access Network (O-RAN), network energy saving (NES) information from at least one of an O-RAN Distributed Unit (O-DU) and an O-RAN Centralized Unit (O-CU), wherein the NES information includes capability exposing information received from an O-RAN Radio Unit (O-RU); determining, by the SMO based at least in part on the NES information, whether to activate an NES use-case; based on determining to activate the NES use-case, sending, by the SMO, a trigger to activate the NES use-case; and receiving, by the SMO, a first notification indicating a change in a state of the NES use-case.

Item [16]: The at least one-transitory computer-readable recording medium according to Item [15], the method, further including: receiving, by the SMO, further NES information including traffic load performance and energy consumption measurements from at least one of the O-DU and the O-CU; determining, by the SMO based at least in part on the further NES information, whether to deactivate the NES use-case; based on determining to deactivate the NES use-case, sending, by the SMO, a trigger to the O-CU to deactivate the NES use-case; and receiving, by the SMO, a second notification indicating a change in the state of the NES use-case.

Item [17]: The at least one-transitory computer-readable recording medium according to any one of Items [15]-[16], wherein: the NES use-case is Cell and Carrier Switch Off/On; the trigger is sent to the O-CU; based on receiving the trigger, the O-CU is configured to send a request to the O-DU to request deactivation of cells and associated carriers; based on receiving the request, the O-DU is configured to process Cell and Carrier Switch Off to an O-RU via a management plane (M-Plane) to set the O-RU into an energy saving state; and the O-RU is configured to be set into the energy saving state by disabling an associated array-carrier.

Item [18]: The at least one-transitory computer-readable recording medium according to any one of Items [15]-[16], wherein: the NES use-case is TRx control, wherein the trigger is sent to the O-DU; based on receiving the trigger, the O-DU is configured to send attributes and parameters to the O-CU to update a Synchronization Signal Block (SSB) configuration, and send a Section type 4 Control Plane (ST4 C-Plane) message with TRx control associated parameters to the O-RU to set the O-RU into an energy saving state; and the O-RU is set into the energy saving state by turning off appropriate RF Channels and Antenna Elements based on the ST4 C-Plane message.

Item [19]: The at least one-transitory computer-readable recording medium according to Item [18], wherein: the determining whether to activate the NES use-case is further based on using an Artificial Intelligence (AI) or machine learning (ML) algorithm; and the method further includes, based on determining to not activate the NES use-case, sending, by the SMO, a message to the O-CU and the O-DU indicating to not activate TRx control.

Item [20]: The at least one-transitory computer-readable recording medium according to any one of Items [15]-[16], wherein: the NES use-case is Advanced Sleep Mode (ASM); the trigger is sent to the O-DU; based on receiving the trigger, the O-DU is configured to either stop sending configuration update(s) to the O-CU, or send attributes and parameters to the O-CU to update a SSB configuration, and send a ST4 C-Plane message with Sleep Mode associated parameters to the O-RU to set the O-RU into an energy saving state; and the O-RU is set into the energy saving state by putting the O-RU to sleep or putting components of the O-RU to sleep based on the ST4 C-Plane message.

It can be understood that numerous modifications and variations of the present disclosure are possible in light of the above teachings. It will be apparent that within the scope of the appended clauses, the present disclosures may be practiced otherwise than as specifically described herein.

What is claimed is:

1. A method, comprising:
receiving, by a Service Management and Orchestration (SMO) of an Open Radio Access Network (O-RAN), network energy saving (NES) information from at least one of an O-RAN Distributed Unit (O-DU) and an O-RAN Centralized Unit (O-CU), wherein the NES information includes capability exposing information received from an O-RAN Radio Unit (O-RU);
determining, by the SMO based at least in part on the NES information, whether to activate an NES use-case;
based on determining to activate the NES use-case, sending, by the SMO, a trigger to activate the NES use-case; and
receiving, by the SMO, a first notification indicating a change in a state of the NES use-case.

2. The method as claimed in claim 1, further comprising:
receiving, by the SMO, further NES information including traffic load performance and energy consumption measurements from at least one of the O-DU and the O-CU;
determining, by the SMO based at least in part on the further NES information, whether to deactivate the NES use-case;
based on determining to deactivate the NES use-case, sending, by the SMO, a trigger to the O-CU to deactivate the NES use-case; and
receiving, by the SMO, a second notification indicating a change in the state of the NES use-case.

3. The method as claimed in claim 1, wherein:
the NES use-case is Cell and Carrier Switch Off/On;
the trigger is sent to the O-CU;
based on receiving the trigger, the O-CU is configured to send a request to the O-DU to request deactivation of cells and associated carriers;
based on receiving the request, the O-DU is configured to process Cell and Carrier Switch Off to an O-RU via a management plane (M-Plane) to set the O-RU into an energy saving state; and
the O-RU is configured to be set into the energy saving state by disabling an associated array-carrier.

4. The method as claimed in claim 1, wherein:
the NES use-case is TRx control, wherein the trigger is sent to the O-DU;
based on receiving the trigger, the O-DU is configured to send attributes and parameters to the O-CU to update a Synchronization Signal Block (SSB) configuration, and send a Section type 4 Control Plane (ST4 C-Plane) message with TRx control associated parameters to the O-RU to set the O-RU into an energy saving state; and
the O-RU is set into the energy saving state by turning off appropriate RF Channels and Antenna Elements based on the ST4 C-Plane message.

5. The method as claimed in claim 4, wherein:
the determining whether to activate the NES use-case is further based on using an Artificial Intelligence (AI) or machine learning (ML) algorithm; and
the method further comprises, based on determining to not activate the NES use-case, sending, by the SMO, a message to the O-CU and the O-DU indicating to not activate TRx control.

6. The method as claimed in claim 1, wherein:
the NES use-case is Advanced Sleep Mode (ASM);
the trigger is sent to the O-DU;
based on receiving the trigger, the O-DU is configured to either stop sending configuration update(s) to the O-CU, or send attributes and parameters to the O-CU to update a SSB configuration, and send a ST4 C-Plane message with Sleep Mode associated parameters to the O-RU to set the O-RU into an energy saving state; and
the O-RU is set into the energy saving state by putting the O-RU to sleep or putting components of the O-RU to sleep based on the ST4 C-Plane message.

7. The method as claimed in claim 1, wherein the NES information comprises NES use-case(s) related capabilities, traffic load performance, and energy consumption measurements.

8. A Service Management and Orchestration (SMO) of an Open Radio Access Network (O-RAN) configured to:
receive network energy saving (NES) information from at least one of an O-RAN Distributed Unit (O-DU) and an O-RAN Centralized Unit (O-CU), wherein the NES information includes capability exposing information received from an O-RAN Radio Unit (O-RU);
determine based at least in part on the NES information, whether to activate an NES use-case;
based on determining to activate the NES use-case, send a trigger to activate the NES use-case; and
receive a first notification indicating a change in a state of the NES use-case.

9. The SMO as claimed in claim 8, further configured to:
receive further NES information including traffic load performance and energy consumption measurements from at least one of the O-DU and the O-CU;
determine based at least in part on the further NES information, whether to deactivate the NES use-case;
based on determining to deactivate the NES use-case, send a trigger to the O-CU to deactivate the NES use-case; and
receive a second notification indicating a change in the state of the NES use-case.

10. The SMO as claimed in claim 8, wherein:
the NES use-case is Cell and Carrier Switch Off/On;
the trigger is sent to the O-CU;
based on receiving the trigger, the O-CU is configured to send a request to the O-DU to request deactivation of cells and associated carriers;
based on receiving the request, the O-DU is configured to process Cell and Carrier Switch Off to an O-RU via a management plane (M-Plane) to set the O-RU into an energy saving state; and
the O-RU is configured to be set into the energy saving state by disabling an associated array-carrier.

11. The SMO as claimed in claim 8, wherein:
the NES use-case is TRx control, wherein the trigger is sent to the O-DU;
based on receiving the trigger, the O-DU is configured to send attributes and parameters to the O-CU to update a Synchronization Signal Block (SSB) configuration, and send a Section type 4 Control Plane (ST4 C-Plane) message with TRx control associated parameters to the O-RU to set the O-RU into an energy saving state; and
the O-RU is set into the energy saving state by turning off appropriate RF Channels and Antenna Elements based on the ST4 C-Plane message.

12. The SMO as claimed in claim 11, wherein:
the SMO is configured to determine whether to activate the NES use-case further based on using an Artificial Intelligence (AI) or machine learning (ML) algorithm; and
the SMO is further configured to, based on determining to not activate the NES use-case, send a message to the O-CU and the O-DU indicating to not activate TRx control.

13. The SMO as claimed in claim 8, wherein:
the NES use-case is Advanced Sleep Mode (ASM);
the trigger is sent to the O-DU;
based on receiving the trigger, the O-DU is configured to either stop sending configuration update(s) to the O-CU, or send attributes and parameters to the O-CU to update a SSB configuration, and send a ST4 C-Plane message with Sleep Mode associated parameters to the O-RU to set the O-RU into an energy saving state; and
the O-RU is set into the energy saving state by putting the O-RU to sleep or putting components of the O-RU to sleep based on the ST4 C-Plane message.

14. The SMO as claimed in claim 8, wherein the NES information comprises NES use-case(s) related capabilities, traffic load performance, and energy consumption measurements.

15. At least one non-transitory computer-readable recording medium having recorded thereon instructions executable to implement a method comprising:
receiving, by a Service Management and Orchestration (SMO) of an Open Radio Access Network (O-RAN), network energy saving (NES) information from at least one of an O-RAN Distributed Unit (O-DU) and an O-RAN Centralized Unit (O-CU), wherein the NES information includes capability exposing information received from an O-RAN Radio Unit (O-RU);
determining, by the SMO based at least in part on the NES information, whether to activate an NES use-case;
based on determining to activate the NES use-case, sending, by the SMO, a trigger to activate the NES use-case; and
receiving, by the SMO, a first notification indicating a change in a state of the NES use-case.

16. The at least one-transitory computer-readable recording medium as claimed in claim 15, the method, further comprising:
receiving, by the SMO, further NES information including traffic load performance and energy consumption measurements from at least one of the O-DU and the O-CU;
determining, by the SMO based at least in part on the further NES information, whether to deactivate the NES use-case;
based on determining to deactivate the NES use-case, sending, by the SMO, a trigger to the O-CU to deactivate the NES use-case; and
receiving, by the SMO, a second notification indicating a change in the state of the NES use-case.

17. The at least one-transitory computer-readable recording medium as claimed in claim 15, wherein:
the NES use-case is Cell and Carrier Switch Off/On;
the trigger is sent to the O-CU;
based on receiving the trigger, the O-CU is configured to send a request to the O-DU to request deactivation of cells and associated carriers;
based on receiving the request, the O-DU is configured to process Cell and Carrier Switch Off to an O-RU via a management plane (M-Plane) to set the O-RU into an energy saving state; and
the O-RU is configured to be set into the energy saving state by disabling an associated array-carrier.

18. The at least one-transitory computer-readable recording medium as claimed in claim 15, wherein:
the NES use-case is TRx control, wherein the trigger is sent to the O-DU;
based on receiving the trigger, the O-DU is configured to send attributes and parameters to the O-CU to update a Synchronization Signal Block (SSB) configuration, and send a Section type 4 Control Plane (ST4 C-Plane) message with TRx control associated parameters to the O-RU to set the O-RU into an energy saving state; and
the O-RU is set into the energy saving state by turning off appropriate RF Channels and Antenna Elements based on the ST4 C-Plane message.

19. The at least one-transitory computer-readable recording medium as claimed in claim 18, wherein:
the determining whether to activate the NES use-case is further based on using an Artificial Intelligence (AI) or machine learning (ML) algorithm; and
the method further comprises, based on determining to not activate the NES use-case, sending, by the SMO, a message to the O-CU and the O-DU indicating to not activate TRx control.

20. The at least one-transitory computer-readable recording medium as claimed in claim 15, wherein:
the NES use-case is Advanced Sleep Mode (ASM);
the trigger is sent to the O-DU;
based on receiving the trigger, the O-DU is configured to either stop sending configuration update(s) to the O-CU, or send attributes and parameters to the O-CU to update a SSB configuration, and send a ST4 C-Plane message with Sleep Mode associated parameters to the O-RU to set the O-RU into an energy saving state; and
the O-RU is set into the energy saving state by putting the O-RU to sleep or putting components of the O-RU to sleep based on the ST4 C-Plane message.
